(19) United States
(12) Patent Application Publication
(10) Pub. No.: US 2026/0140341 A1
(43) Pub. Date: May 21, 2026

(54) ASSEMBLY INCLUDING AN INTEGRATED FIBER LOOP STORAGE BASKET FOR AN OPTICAL FIBER MANAGEMENT ASSEMBLY

(71) Applicant: CommScope Technologies LLC, Hickory, NC (US)

(72) Inventors: Bart Mattie CLAESSENS, Hasselt (BE); Johan GEENS, Bunsbeek (BE); Geert VAN GENECHTEN, Vorselaar (BE); Peter Jozef Romain WAETERSCHOOT, Berchem (BE)

(21) Appl. No.: 18/705,798

(22) PCT Filed: Oct. 31, 2022
(86) PCT No.: PCT/US2022/048445

§ 371 Date: Apr. 29, 2024

Related U.S. Application Data
(60) Provisional application No. 63/273,363, filed on Oct. 29, 2021.
(60) Provisional application No. 63/336,330, filed on Apr. 29, 2022.

(51) Int. Cl. G02B 6/44

(52) U.S. Cl. CPC G02B 6/4445; G02B 6/4444; G02B 6/4454; G02B 6/4455

(57) ABSTRACT

Optical fiber management assemblies. The assemblies can be installed in telecommunications equipment, such as telecommunications closures. The assemblies include parts with multiple features unitarily integrated therewith, minimizing the number of parts needed to manufacture, process, and put together the assembly. In some embodiments, the assemblies are adjustable in size depending on fiber management needs.

### CROSS-REFERENCE TO RELATED APPLICATIONS

This application is being filed on Oct. 31, 2022 as a PCT International Patent Application and claims the benefit of U.S. Patent Application Ser. No. 63/273,363, filed on Oct. 29, 2021 and claims the benefit of U.S. Patent Application Ser. No. 63/336,330, filed on Apr. 29, 2022, the disclosures of which are incorporated herein by reference in their entireties.

### TECHNICAL FIELD

The present disclosure relates to improvements in assemblies for routing and organizing optical fibers at telecommunications equipment.

### BACKGROUND

Optical fibers of telecommunications networks are managed at telecommunications equipment located at different network distribution locations. Such telecommunications equipment can include closures, cabinets, shelves, panels and so forth. The equipment typically includes management assemblies to organize, store, route and connect optical fibers within the network. For example, optical fibers from provider side cables can be routed and optically connected to optical fibers of subscriber side cables using such assemblies. The assemblies can include features for supporting optical fiber splices, ferrules, connectors, adapters, splitters, wave division-multiplexers and so forth. In addition, the assemblies can include features for storing and protecting optical fibers. In addition, the assemblies can include features for fixing end portions of cable jackets so that optical fibers can emerge from the cable jackets and be organized on the other equipment. In addition, the assemblies can include features for securing and guiding protective tubes that hold lengths of optical fibers beyond where they have emerged from the cable jackets.

The assemblies can include fiber management trays, which can be used to, e.g., support splices and other fiber management components between incoming and outgoing optical fibers that are routed onto the trays. A typical fiber management assembly can include a support structure to which multiple fiber management trays are pivotally mounted in a stack. The pivoting permits access to a desired one of the stack of trays.

The assemblies can include baskets for storing loops of optical fibers on the assembly without necessarily routing them to a fiber management tray.

### SUMMARY

In general terms, the present disclosure relates to improvements in optical fiber management assemblies.

In further general terms, the present disclosure relates to improvements in fiber optic closures and other fiber optic distribution equipment.

In further general terms, the present disclosure is directed to optical fiber management assemblies that optimize various attributes of the assembly, such as ease of assembling, number of pieces, and strength of the assembly. For instance, assemblies and pieces of assemblies of the present disclosure can minimize the number of pieces needed for the assembly, while maximizing strength of the assembly and ease of assembling the assembly.

In further general terms, the present disclosure is directed to optical fiber management assemblies with improved versatility in configuring the assembly for different optical fiber management needs.

According to one aspect, the present disclosure is directed to optical fiber management assemblies having a component (or piece) with multiple features unitarily integrated therewith, such that the component can serve multiple functions. As used herein, unitarily integrated, unitarily constructed, and like terms, mean that the component having the features is a single, seamless piece. An example of such a unitarily constructed piece is one that has been manufactured in a single molding step, with all unitarily integrated features of the piece formed in that molding step.

According to another aspect, the present disclosure is directed to a piece of an optical fiber management assembly, the piece including, unitarily integrated therewith, a baseplate for mounting a portion of a cable jacket fixation subassembly and a basket for storing loops of optical fibers.

According to another aspect, the present disclosure is directed to a piece of an optical fiber management assembly, the piece including, unitarily integrated therewith, a baseplate for mounting a cable jacket termination unit, a basket for storing loops of optical fibers, and structures for mounting modules configured to pivotally support stacks of fiber management trays.

According to another aspect, the present disclosure is directed to a piece of an optical fiber management assembly, the piece including, unitarily integrated therewith, a baseplate for mounting a portion of a cable jacket fixation subassembly and structures for mounting modules configured to pivotally support stacks of fiber management trays.

According to another aspect, the present disclosure is directed to a piece of an optical fiber management assembly, the piece including, unitarily integrated therewith, a baseplate for mounting a cable jacket termination unit, a fiber router including a spool structure and/or a structure for mounting a fiber sheath holding module, and structures for mounting modules configured to pivotally support stacks of fiber management trays.

According to another aspect, the present disclosure is directed to a piece of an optical fiber management assembly, the piece including, unitarily integrated therewith, a baseplate for mounting a portion of a cable jacket fixation subassembly and a fiber router including a spool structure and/or a structure for mounting a module configured to hold protective sheaths of optical fibers.

According to another aspect, the present disclosure is directed to a piece of an optical fiber management assembly, the piece including, unitarily integrated therewith, a baseplate for mounting a portion of a cable jacket fixation subassembly and a fiber router including a spool structure and/or a structure for mounting a fiber sheath holding module, and a basket for storing loops of optical fibers.

According to another aspect, the present disclosure is directed to a subassembly of an optical fiber management assembly, the subassembly including a first piece and a second piece that include interfaces configured to snappingly connect to each other, the first piece including, unitarily integrated therewith, a baseplate for mounting a portion of a cable jacket fixation subassembly and structures for mounting modules configured to pivotally support stacks of fiber management trays, and the second piece including, unitarily integrated therewith, a baseplate for mounting a portion of a cable jacket fixation subassembly and a fiber router including a spool structure and/or a structure for mounting a module configured to hold protective sheaths of optical fibers.

According to another aspect, the present disclosure is directed to a subassembly of an optical fiber management assembly, the subassembly including a first piece and a second piece that include interfaces that are configured to snappingly connect to each other, the first piece including, unitarily integrated therewith, a baseplate for mounting a cable jacket termination unit, a basket for storing loops of optical fibers, and structures for mounting modules configured to pivotally support stacks of fiber management trays, and the second piece including, unitarily integrated therewith, a baseplate for mounting a portion of a cable jacket fixation subassembly, and a fiber router including a spool structure and/or a structure for mounting a module configured to hold protective sheaths of optical fibers.

According to another aspect, the present disclosure is directed to a subassembly of an optical fiber management assembly, the subassembly including a first piece and a second piece that include interfaces that are configured to snappingly connect to each other, the first piece including, unitarily integrated therewith, a baseplate for mounting a cable jacket termination unit, a fiber router including a spool structure and/or a structure for mounting a module configured to hold protective sheaths of optical fibers, a basket for storing loops of optical fibers, and structures for mounting modules configured to pivotally support stacks of fiber management trays, and the second piece including, unitarily integrated therewith, a baseplate for mounting a portion of a cable jacket fixation subassembly and a fiber router including a spool structure and/or a structure for mounting a module configured to hold protective sheaths of optical fibers.

According to certain specific aspects of the present disclosure, an optical fiber management assembly, includes: an optical fiber management assembly, comprising: a piece including, unitarily integrated therewith, at least two of: (i) a baseplate for mounting a portion of a cable jacket fixation subassembly to the baseplate; (ii) a basket for storing loops of optical fibers; and (iii) a fiber router including two spool structures.

According to further specific aspects of the present disclosure, an optical fiber management assembly, includes: a piece including, unitarily integrated therewith: a baseplate for mounting a portion of a cable jacket fixation subassembly to the baseplate; (ii) a basket for storing loops of optical fibers; and (iii) a fiber router including two spool structures, the fiber router being positioned between the baseplate and the basket.

According to further specific aspects of the present disclosure, an optical fiber management assembly, includes: a basket for storing loops of optical fibers; and a basket expansion piece configured to snap connect to the basket to expand the size of the basket and increase optical fiber loop storage capacity of the basket.

As used herein, mounting refers to direct mounting between the components. For example, as used herein, that a first component includes structures for mounting a second component means that the second component can be directly mounted to the structures of the first component without any need for an additional or intermediating component to perform the mounting.

A variety of additional inventive aspects will be set forth in the description that follows. The inventive aspects can relate to individual features and to combinations of features. It is to be understood that both the forgoing general description and the following detailed description are exemplary and explanatory only and are not restrictive of the broad inventive concepts upon which the examples disclosed herein are based.

### BRIEF DESCRIPTION OF THE DRAWINGS

The following drawings are illustrative of particular embodiments of the present disclosure and therefore do not limit the scope of the present disclosure. The drawings are not necessarily to scale and are intended for use in conjunction with the explanations in the following detailed description. Embodiments of the present disclosure will hereinafter be described in conjunction with the appended drawings, wherein like numerals denote like elements.

FIG. 1 is a perspective view of example telecommunications equipment that can support an optical fiber management assembly according to the present disclosure.

FIG. 2 is a further perspective view of the equipment of FIG. 1.

FIG. 3 is a perspective view of an example optical fiber management assembly according to the present disclosure, and including schematically represented seal blocks and a schematically represented fiber optic cable.

FIG. 4 is a further perspective view of the assembly of FIG. 3.

FIG. 5 is a perspective view of a portion of the assembly of FIG. 3.

FIG. 6 is an exploded view of the assembly of FIG. 3.

FIG. 7 is a further exploded view of the assembly of FIG. 3.

FIG. 8 is a perspective view of a further portion of the assembly of FIG. 3.

FIG. 9 is an exploded view of the portion of the assembly of FIG. 8.

FIG. 10 is a further exploded view of the portion of the assembly of FIG. 8.

FIG. 11 is a perspective view of one of the pieces of the assembly of FIG. 3.

FIG. 12 is a further perspective view of the piece of FIG. 11.

FIG. 13 is a perspective view of another one of the pieces of the assembly of FIG. 3.

FIG. 14 is a further perspective view of the piece of FIG. 13.

FIG. 15 is a front planar view of the piece of FIG. 13.

FIG. 16 is a rear planar view of the piece of FIG. 13.

FIG. 17 is a perspective view of another one of the pieces of the assembly of FIG. 3.

FIG. 18 is a further perspective view of the piece of FIG. 17.

FIG. 19 is a rear planar view of the piece of FIG. 17.

FIG. 20 is a front planar view of the piece of FIG. 17.

FIG. 21 is a perspective view of a fully interconnected subassembly of the assembly of FIG. 3.

FIG. 22 is an enlarged view of the called-out portion in FIG. 21.

FIG. 23 is an end view of the subassembly of FIG. 21.

FIG. 24 is a perspective, cross-sectional view of the subassembly of FIG. 17 along the line A-A in FIG. 23.

FIG. 25 is an enlarged view of the called-out portion of FIG. 22.

FIG. 26 is a perspective view of an example cable jacket fixation subassembly and cable that can be mounted to the assembly of FIG. 3.

FIG. 27 is a perspective view of a portion of the subassembly of FIG. 26.

FIG. 28 is a perspective view of a component of a cable jacket fixation subassembly that can be mounted to the assembly of FIG. 3.

FIG. 29 is a further perspective view of the component of FIG. 28.

FIG. 30 is a perspective view of further example telecommunications equipment that can support an optical fiber management assembly according to the present disclosure.

FIG. 31 is a perspective view of an example size adjustable optical fiber management assembly according to the present disclosure in a first size configuration.

FIG. 32 is a further perspective view of the assembly of FIG. 31.

FIG. 33 is a partially exploded view of the assembly of FIG. 31.

FIG. 34 is a further partially exploded view of the assembly of FIG. 31.

FIG. 35 is a perspective view of the assembly of FIG. 31 in a second size configuration.

FIG. 36 is a further perspective view of the assembly and configuration of FIG. 35.

FIG. 37 is a perspective view of a unitary piece of the assembly and configurations of FIGS. 31 and 35.

FIG. 38 is a further perspective view of the piece of FIG. 37.

FIG. 39 is a perspective view of the basket expansion piece of the assembly and configuration of FIG. 31.

FIG. 40 is a further perspective view of the expansion piece of FIG. 39.

FIG. 41 is an enlarged view of a portion of the assembly of FIG. 31 where the piece of FIG. 37 and the expansion piece of FIG. 39 interconnect.

FIG. 42 is an enlarged view of a further portion of the assembly of FIG. 31 where the piece of FIG. 37 and the expansion piece of FIG. 39 interconnect.

### DETAILED DESCRIPTION

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Any examples set forth in this specification are not intended to be limiting and merely set forth some of the many possible embodiments for the claimed invention.

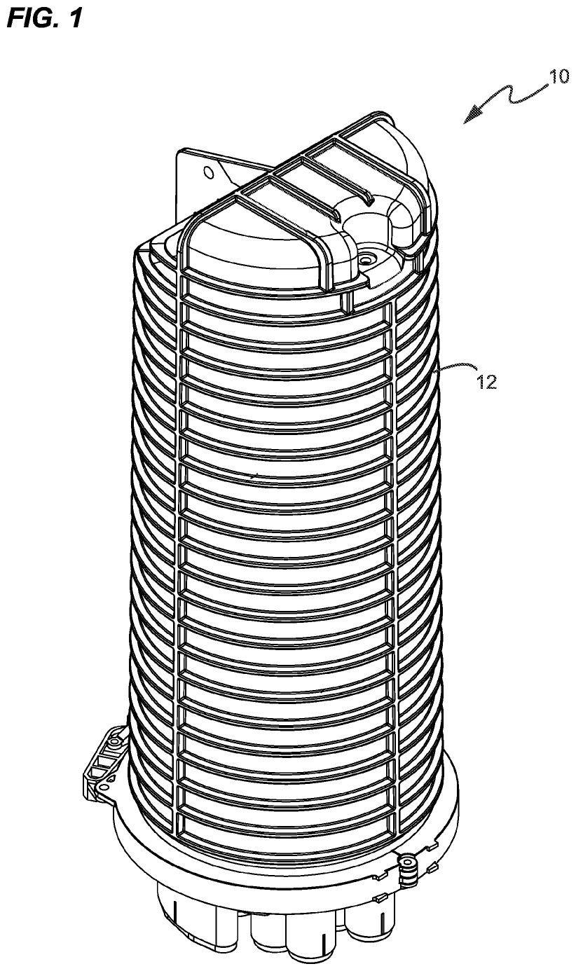

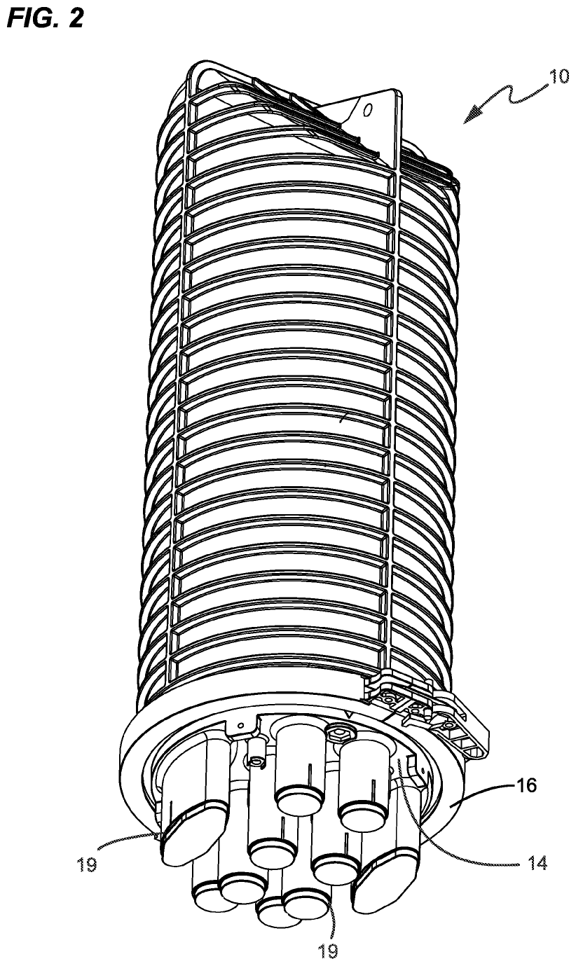

Referring to FIGS. 1-2, example telecommunications equipment 10 is shown. In the depicted example, the equipment 10 includes a sealable and re-enterable closure. In other examples, the equipment can include other components at a distribution location of an optical fiber network. Such equipment can include, for example, a cabinet, a drawer, a shelf, or a panel for organizing and routing optical fibers.

The closure 10 includes a first housing piece 12 (in this case, a dome), and a second housing piece 14 configured to cooperate with the first housing piece to define a sealable and re-enterable telecommunications closure for managing optical fibers. The first and second housing pieces 12, 14 define an interior closure volume in which other fiber managing equipment, including an optical fiber management assembly according to the present disclosure, can be positioned.

A clamp ring 16 having a clamp can be used to clamp and seal together the housing pieces 12 and 14.

Cables carrying optical fibers can enter the closure volume via sealable ports 19 defined by the second housing piece 14. Such cables can include trunk cables, feeder cables, branch cables, and distribution cables (also known as drop cables). Typically, optical fibers from one cable entering the closure are spliced to optical fibers of one or more other cables entering the closure to establish an optical signal path at the closure 10 (or other signal distribution equipment) from a provider side cable to one or more customer side cables, or an optical signal between a branch cable and any of: another branch cable, a trunk cable, a feeder cable, or a distribution cable. Branch cables can be used to route optical signals from one telecommunications closure to another telecommunications closure.

In addition to splicing, other fiber management activities can be performed with telecommunications equipment housed within the closure volume. Such activities can include, without limitation, indexing fibers, storing fibers (typically in one or more loops) and splitting fibers.

Splices, such as mechanical splices or fusion splices, can be performed at the factory or in the field, e.g., at the closure 10 positioned in the field.

The cables entering the closure can include optical fibers of different configurations such as loose fibers and fiber ribbons. The fiber ribbons can be flat ribbons or rollable ribbons. The loose fibers can be individual fibers or bundled loose fibers protected by a common protective sheath or tube. For fiber ribbons, the fibers of the entire ribbon can be spliced to the fibers of a corresponding fiber ribbon at the same time, e.g., using a mass fusion splicing procedure.

Splice bodies protect the splices both in the case of individual fiber splices and mass fiber splices, such as mass fusion splices. The splice bodies are held in splice holders also known as splice chips. Fiber management trays of a fiber management assembly positioned in the interior sealable and re-enterable volume defined by the closure 10 can support such splice holders (or chips), as further described below.

As used herein, positioning and orientational terms such as up, down, upper, lower, above, below, front, back, rear, forward, backward, rearward, horizontal, vertical, and so forth, may be used to refer to relative positioning of components in an assembly or portions of a component relative to each other when positioned in an assembly. Such terminology is provided as a descriptive aid and does not limit how components or portions of components may be positioned or oriented in practice.

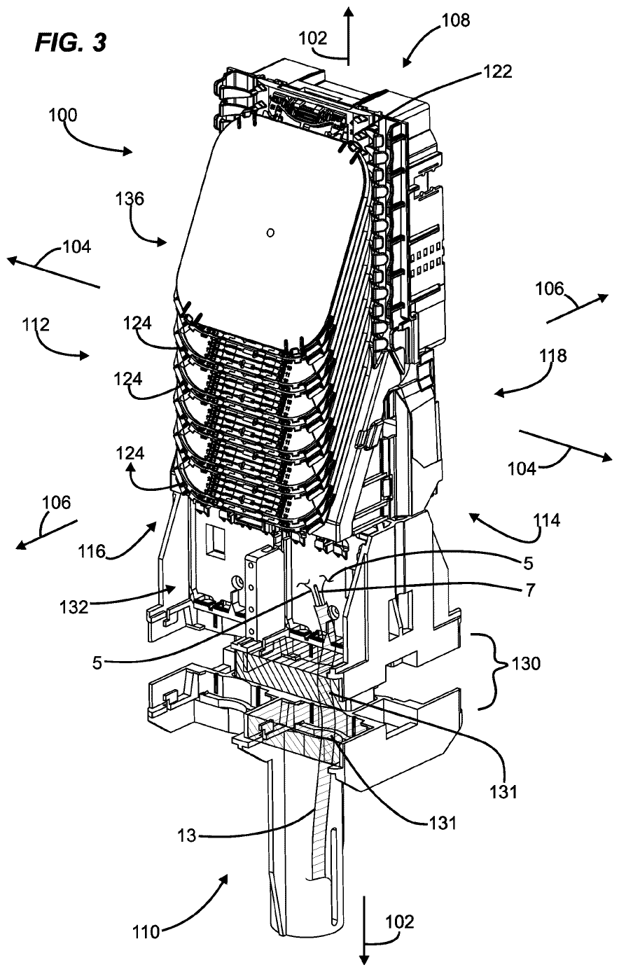

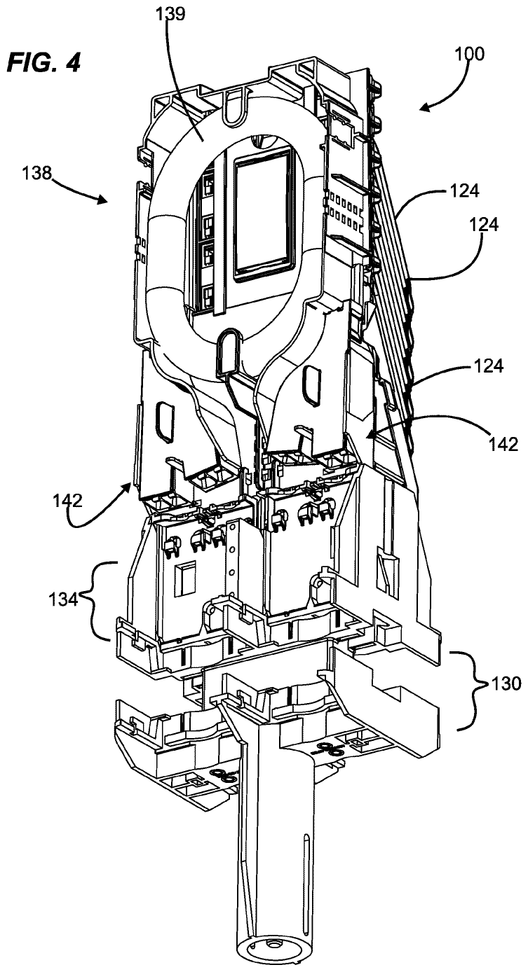

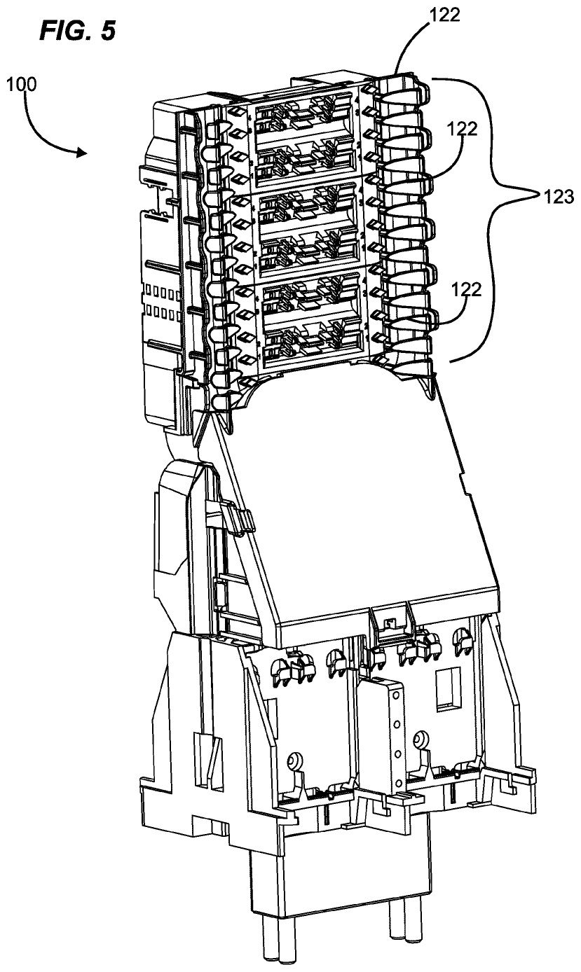

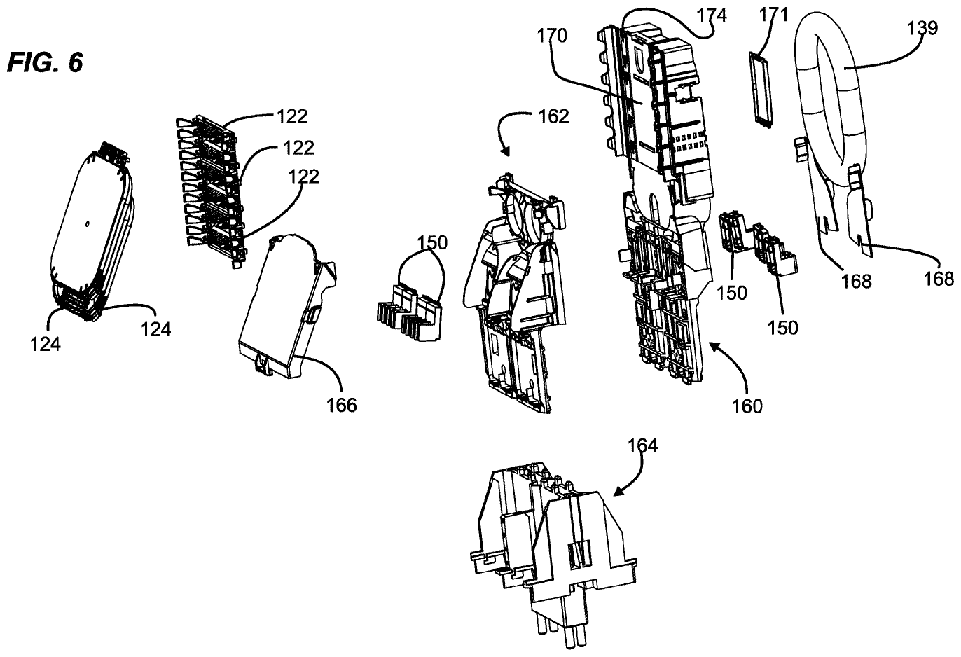

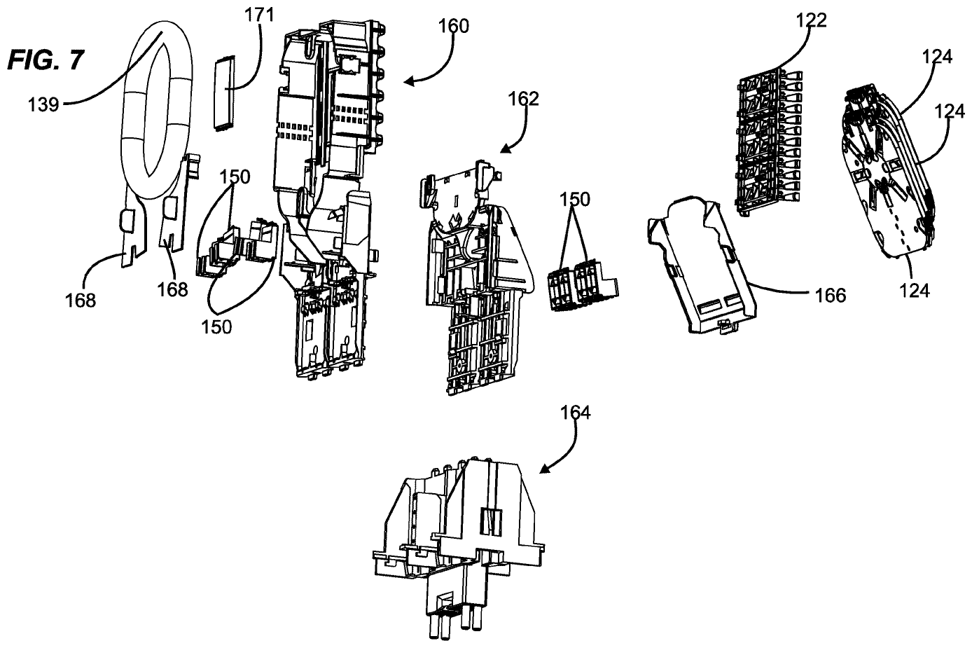

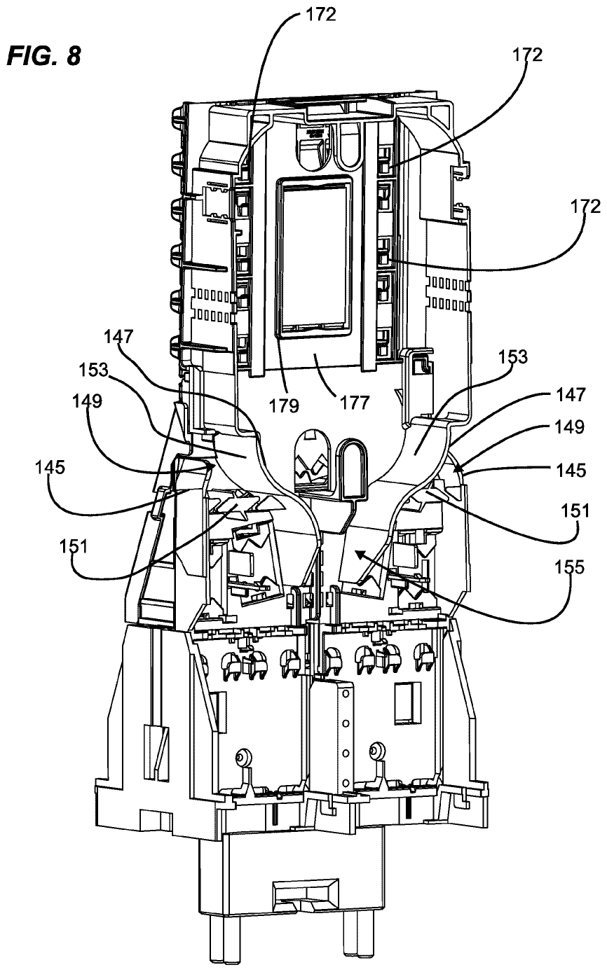

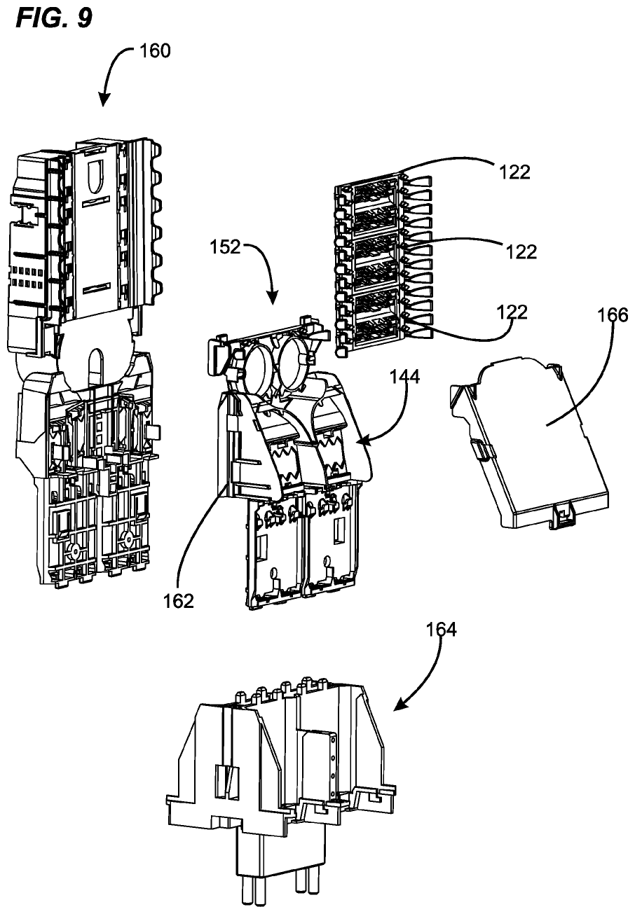

Referring now to FIGS. 3-10, an assembly 100 in accordance with the present disclosure, and that can be housed in the closure 10 of FIG. 1, will be described. In addition, components of the assembly 100 can be installed on or in other telecommunications equipment that are not sealable closures, such as cabinets, panels, drawers, racks, shelves, and so forth.

The assembly 100, as well as individual components of the assembly 100 and various combinations of the components of the assembly 100, can provide one or more advantages in manufacturing cost and efficiency, weight reduction, assembly cost and efficiency, and versatility in using the components of the assembly across different network applications. Aspects of the assembly 100 can optimize various attributes of the assembly, such as ease of assembling the assembly 100, number of pieces of the assembly 100, and strength of the assembly 100. For instance, through unitarity integration of different fiber management functions and features in single molded piece, or small number of molded pieces, the assembly 100 is configured to minimize the number of pieces needed for the assembly, while maximizing strength of the assembly and ease of assembling the assembly. Additional advantages will be borne out by the following disclosure.

In some examples, pieces of the assembly 100 are constructed of a molded polymeric material.

The assembly 100 defines a first axis, or vertical axis 102, a second axis 104, and a third axis 106. The first axis 102, the second axis 104, and the third axis 106 are mutually perpendicular. The second axis 104 and the third axis 106 define a horizontal plane. The assembly 100 extends from a top 108 to a bottom 110 along the first axis 102. The assembly 100 extends from a first side 112 to a second side 114 along the second axis 104. The assembly 100 extends from a front 116 to a back 118 along the third axis 106.

The assembly 100 also includes a vertical stack 123 of fiber management tray support modules 122. The stack 123 is mounted at a front of the assembly 100. The stack 123 includes a selectable number of modules 122 stacked along a stacking axis, which is parallel to the axis 102.

Each module 122 is configured to pivotally support a plurality of optical fiber management trays 124. Each optical fiber management tray 124 can be used to provide optical signal routing between optical fibers of cables entering the closure or other equipment. For instance, each fiber management tray 124 can include structures (also known as splice chips) that hold splices of optical fibers, where each splice optically connects an optical fiber and another optical fiber. In addition, or alternatively, each tray can support optical fiber adapters that provide an interface for two connectors terminating optical fibers to be optically coupled to each other while secured to the tray. In addition, or alternatively, each tray can support a signal splitter or a wave division multiplexer for further signal management of optical fibers on the tray.

The assembly 100 defines regions with different functions. A cable sealing region 130 of the assembly 100 holds seal blocks that can be pressurized against walls of the sealing region 130 (e.g., using an actuator that compresses a spring mechanism) to form seals around cable jackets of cables entering the closure. Example seal blocks 131 are schematically shown in FIG. 3. A schematically represented cable (e.g., a feeder cable, a branch cable, or a drop cable) 3 is depicted passing through the seal blocks 131 in the cable sealing region 130. The cable sealing region 130 effectively circumferentially surrounds the axis 102.

Above the cable sealing region are a front cable jacket fixation region 132 and a rear cable jacket fixation region 134. Each cable fixation region 132, 134 is configured to mount cable jacket fixation subassemblies. The cable jackets of the cables entering the closure must be anchored to minimize damage to the optical fibers that could result if the cables were to shift within the closure. Optical fibers 5 emerge from the ends of the fixed cable jackets of the cables. The optical fibers 5 can be managed as loose fibers or as groups of fibers protected by sheaths or tubes. Typically, portions of the fibers will be protected by such sheaths, and portions, e.g., portions on the fiber management trays, will not be protected by such sheaths. In some examples, the cables entering the closure can include a strength member 7, such as aramid yarn or a rigid rod. Typically, the strength member 7 is also anchored in the cable jacket fixation region 132, 134 to minimize possible damage to the optical fibers 5.

Above the cable jacket fixation regions 132 and 134 is a front sheath holder region 144 and a rear sheath holder region 142. The sheath holder regions 142 and 144 are for securing sheaths that protect optical fibers extending from the cable jacket fixation regions 132 and 134. Securing the sheaths can minimize possible damage to optical fibers and enhance organization of loose fibers emerging from the ends of the sheaths. Typically, the sheaths can be shaved off at or near the sheath holder regions 142 and 144, and loose fibers continue from the ends of the sheaths.

Above the front sheath holder region 144 at the front of the assembly 100 is a fiber routing region 152. The fiber routing region 152 is configured to route fibers from the front sheath holder region 144 to the appropriate side (left or right) of the fiber management region 136. The fiber routing region 152 is also configured to route fibers from the left and right portions of the rear sheath holder region 142 to the appropriate side (left or right) of the fiber management region 136.

The rear sheath holder region 142 can also serve as a fiber routing region for routing fibers extending from the ends of held sheaths at the rear of the assembly 100 to the fiber routing region 152 at the front of the assembly 100.

The fiber management region 136 of the assembly 100 is positioned at the front of the assembly 100 above the fiber routing region 152. The fiber management region includes the pivotally mounted fiber management trays 124 and the modules 122 that support the trays 124. Fibers enter the trays 124 from the left side and the right side of the fiber routing region 152.

At the rear of the assembly 100 and above the rear sheath holder region 142 is a loop storage region 138. The loop storage region 138 is configured to store loops of optical fibers, schematically represented by the reference number 139. Typically, optical fibers stored in loops in the loop storage region 138 are protected by sheaths or tubes extending from the cable jacket fixation region 134. The fibers remain stored and protected until needed for signal transmission, at which point the relevant tube can be removed from the loop storage region 138, shaved off and held in the sheath holder region 142, and the needed optical fiber routed from the sheath holder region 142 can then be routed to the fiber management region 136.

Inner surfaces 153 of walls 147 define a pathway 155 from the cable jacket fixation region 134 to the loop storage region 138.

The rear sheath holder region 142 includes the walls 146, 147 and fiber retainers 151 that define pathways 149 for loose fibers emerging from held sheaths to be routed to the fiber routing region 152, and from there to the appropriate side (left or right) of the fiber management region 136 at the front of the assembly 100.

The assembly 100 includes pieces that define the foregoing regions and provide the foregoing functions. Some of the pieces advantageously combine multiple features into a single piece of unitary construction, with the features unitarily integrated therewith.

The protective cover includes a first piece 160, a second piece 162, a third piece 164, the sheath holder modules 150, the tray support modules 122, and the fiber management trays 124. In addition, the assembly 100 can include a cover 166, covers 168, and an indicia support piece 171. In some of the views of the assembly, the schematically represented fiber loops 139 are also shown, though it should be appreciated that the fiber loops 139 need not form part of the assembly 100 itself.

The tray modules 122 are mounted to a front facing surface 170 of the piece 160. T-shaped projections of the modules 122 enter openings 174 and slide downward in the openings 174 into engagement. Latch arms at a side of the modules 122 can then be removably snap-connected to the piece 160 to secure the modules 122 to the piece 160.

The trays 124 including pivot shafts that are removably received in a pivotal relationship in shaft receivers of the modules 122.

The sheath holder modules 150 include sheath holders that receive and secure sheaths, e.g., by inserting the sheaths laterally (rather than axially) into labyrinthine passages of the sheath holders. The sheath holder modules 150 including coupling structures for connecting the modules to the pieces 160 and 162.

The cover 166 is configured to snappingly and removably connect to the piece 162 to cover and thereby protect bare fibers in the front sheath holder region 144 and the fiber routing region 152 defined by piece 162.

The covers 168 are configured to snappingly and removably connect to the piece 160 to cover and thereby protect bare fibers in the right and left portions of the rear sheath holder and fiber routing region 142 defined by the piece 160.

The indicia support piece 171 is configured to removably connect (e.g., with an interference fit) onto a raised rib interface 179 projecting rearward from a rearward facing surface 177 of the piece 160. The indicia support piece 171 can be provided with a label or other indicia for identifying the assembly 100 or a portion of the assembly 100.

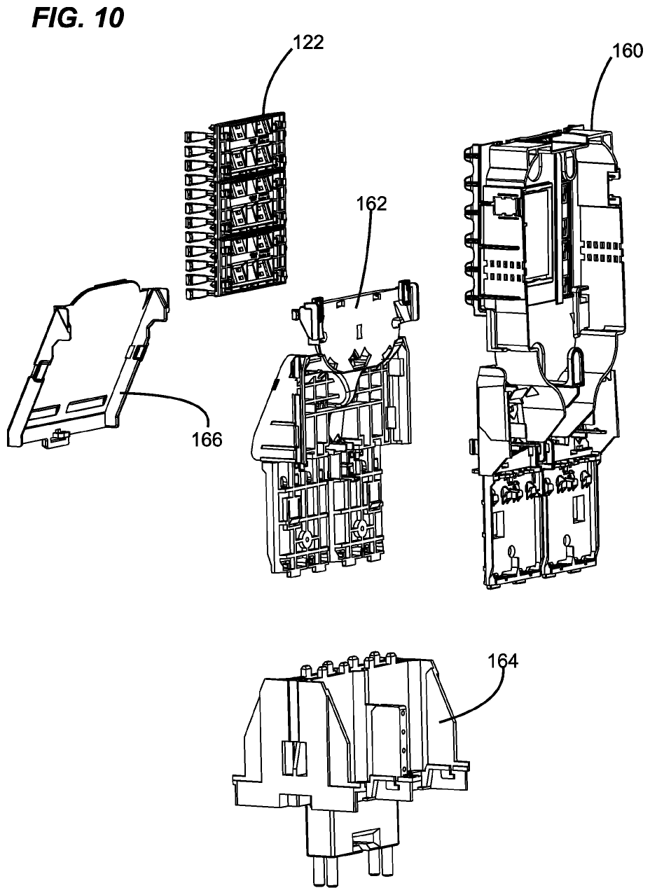

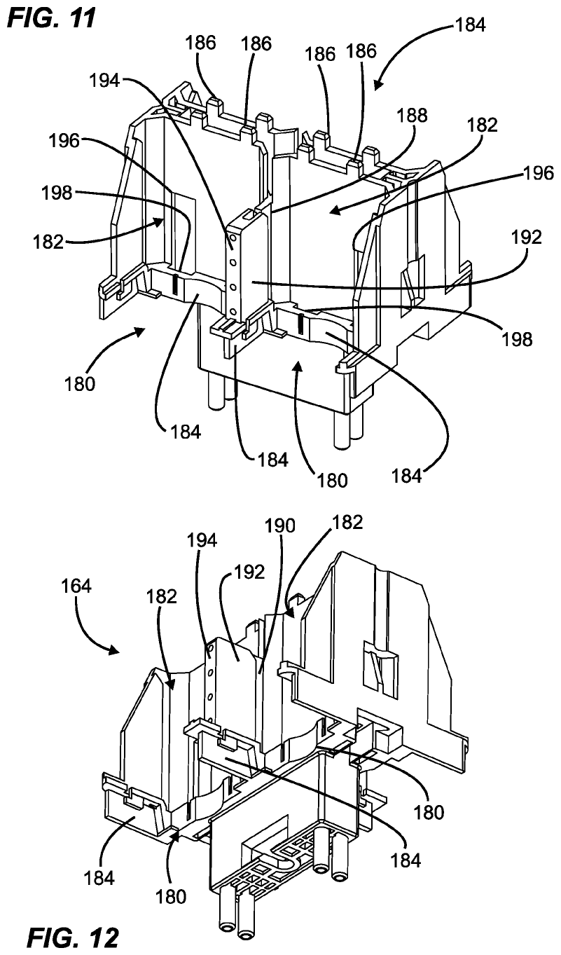

Referring to FIGS. 11-12, the piece 164 is of unitary construction (e.g., formed in a single molding operation). The piece 164 defines first pockets 180 and second pockets 182. The second pockets 182 are above the first pockets 180. The first pockets 180 are configured to receive seal blocks (e.g., gel blocks) that can be pressurized to seal around cables entering the closure, as described above. For example, the seal blocks can be pressurized against surfaces 184 of the pockets 180.

The second pockets 182 are configured to receive by snap-connection portions of the pieces 160 and 162. The pieces 160 and 162 are slid downward into snap-connection with the pockets 182, while projections 186 enter, e.g., by interference fit, openings in the pieces 160 and 162.

The piece 164 includes a front wall or divider 188 and a back wall or divider 190. Each of the walls 188 and 190 is positioned between two of the pockets 182. The wall 188 is positioned between the two front pockets 182, and the wall 190 is positioned between the two rear pockets 182. The walls 188, 190 thus partially define the four pockets 182. In some examples, extending from a wall is body 192 that defines an interface 194. The interface 194 can serve as a location to mount an electrical grounding component that can provide an electrical ground to cables fixed to baseplates of the pieces 160 and 162 in both pockets 182 on either side of each wall 188, 190.

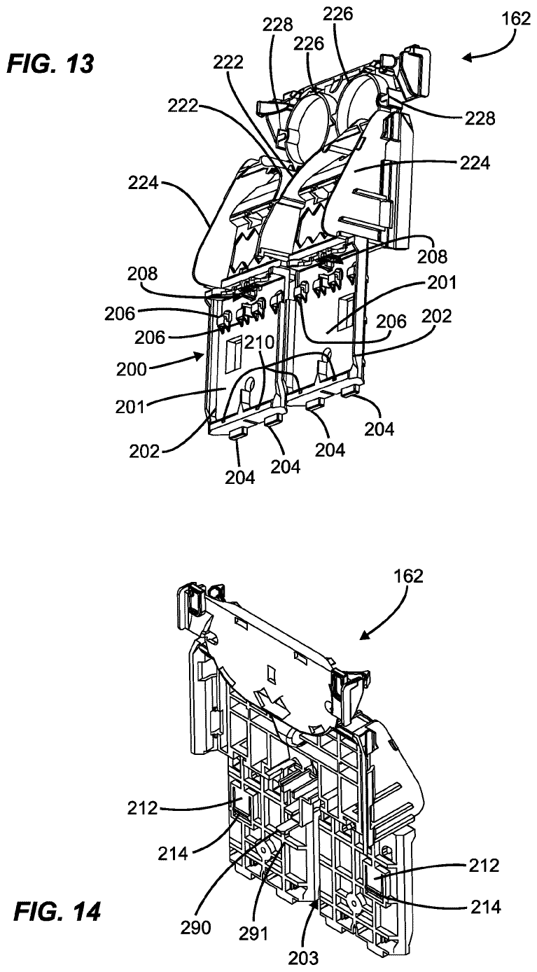

Referring to FIGS. 13-16, the piece 162 is of unitary construction, (e.g., formed in a single molding operation). The piece 162 includes several structures and features unitarily integrated therewith. These structures and features, in turn, provide for multiple cable and fiber management functions of the assembly 100.

The piece 162 includes a baseplate 200. The baseplate 200 consists of right and left baseplate portions 202. A slot 203 devoid of material separates the right and left baseplate portions 202. The baseplate 200 includes a body having downward projections 204. The downward projections 204 are configured to be received (e.g., by interference fit) in receivers 198 of the piece 164 (FIG. 11) when assembling the pieces 162 and 164 together. In addition, the body of the baseplate 200 includes flexibly resilient tabs 212 having projecting catches 214. The tabs 212 are configured to flex until the catches snap into receivers, or openings 196 of the piece 164 (FIG. 11) to snap-connect the pieces 164 and 162 together. In addition, as mentioned above, the projections 186 are received in complementarily configured openings defined by the piece 162 to further connect the pieces 162 and 164.

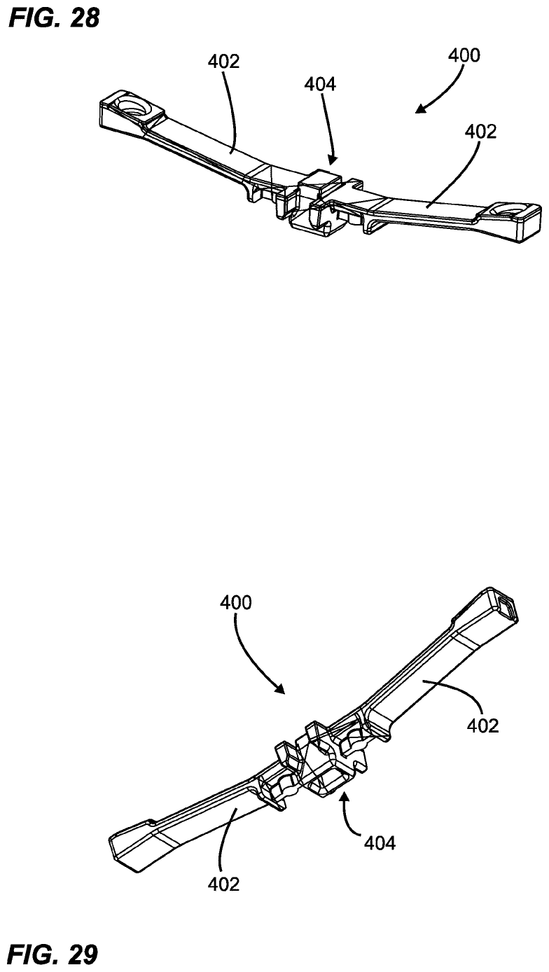

The baseplate 200 includes structures and features for mounting a cable jacket fixation subassembly, which structures and features are unitarily integrated with the piece 162. These structures and features generally project forwards from major forward-facing surfaces 201 of the baseplate 200. These structures and features include a snapping interface 208 for snappingly connecting a retainer, such as the retainer 400 (FIGS. 28-29). The retainer 400 includes flexibly resilient arms 402 extending from a mounting portion 404. The mounting portion 404 snappingly connects to the snapping interface 208. The arms 402 are configured to serve as an upward stop that inhibits upward movement of other portions of a cable jacket fixation a subassembly relative to the baseplate 200. An arm 402 can be flexed rearwardly causing it to pivot relative to the mounting portion 404, to allow another portion of a cable jacket fixation subassembly to be slid upwards for removal from the baseplate 200. The structures and features of the baseplate 200 also include recesses 210 and footholds 206 which are configured to receive complementarily configured portions of cable jacket fixation subassemblies to inhibit movement of such a subassembly in all directions other than upwards, with the retainers 400 serving to inhibit upward movement, thereby providing secure anchoring of a cable jacket fixation subassembly 300 and 400 to the baseplate 200.

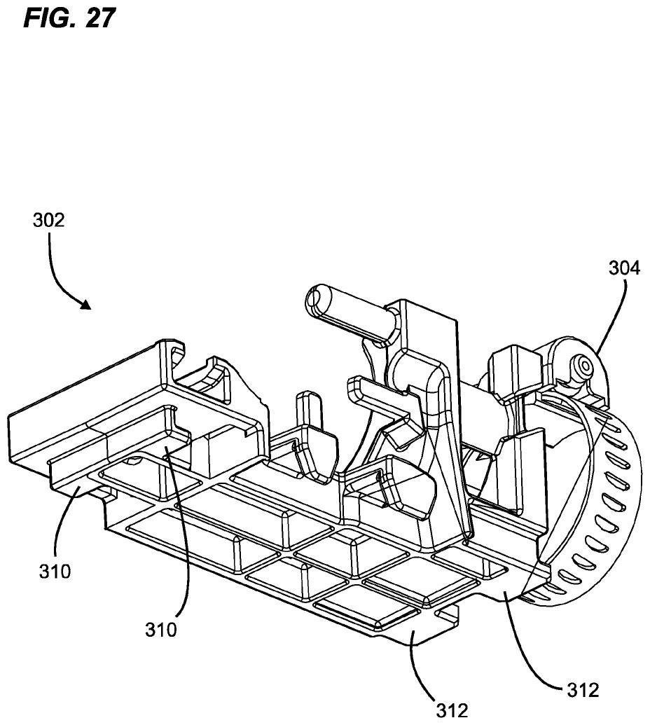

Portions of an example cable fixation subassembly 300 are shown in FIGS. 26-27. The subassembly 300 can be mounted to a surface 201. The subassembly 300 includes a base 302. A cable jacket 9 of a cable 3 is clamped with a cable clamp 304 (e.g., a hose clamp) to the base 302. Emerging from the top end of the cable jacket 9 are one or more optical fibers 5 and a strength member 7. The strength member 7 is fixed to the base 302 with a strength member fixation assembly 308. The subassembly 300 also includes a grounding assembly 306. An electrical grounding conductor can be connected from the grounding assembly 306 to the grounding component positioned at the interface 194 (FIG. 11). The base 302 includes feet 310 and 312. The feet 310 engage, respectively, the footholds 206 and the recesses 210 of the baseplate 200. Together with the retainer 400, the subassembly 300 with the cable 3 in this manner can be secured to the baseplate 200, and the fibers 5 of the cable managed therefrom on portions of the organizer above the baseplate 200.

Above the baseplate 200 the piece 162 includes structures 220 for mounting sheath holder modules 150. The structures 220 can include recesses having shapes that complement projecting shapes of the modules 150. The structures 220 can include additional elements for providing a snap-connection between the piece 162 and the modules 150. The structures 220 are unitarily integrated with the piece 162.

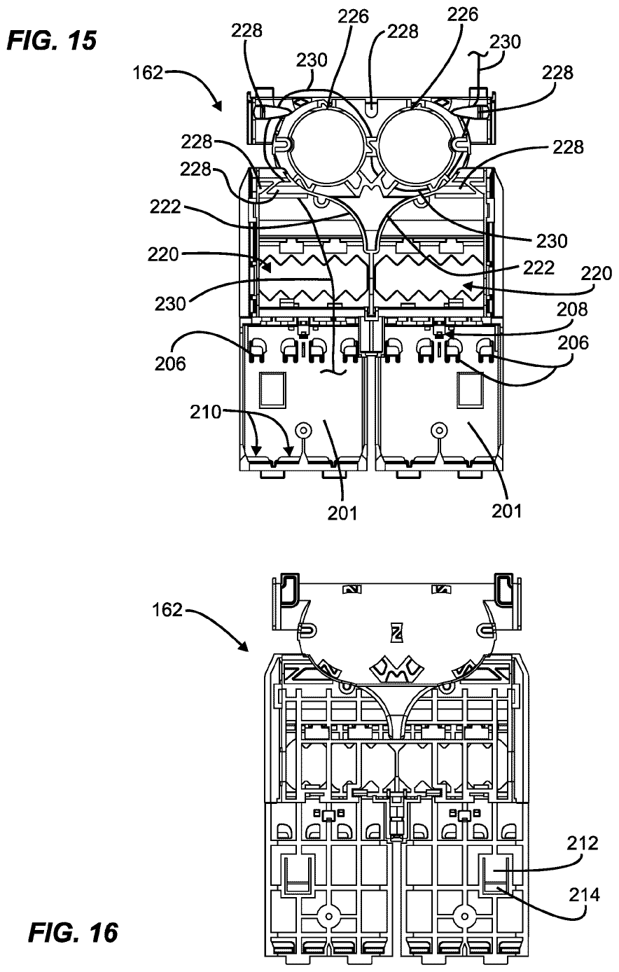

Above the structures 220, the piece 162 includes a fiber router. The router includes walls 222 and 224. The walls 222 and 224, together with fiber retaining fingers 228, are configured to guide optical fibers from the sheath holder modules upward and to the left or right towards the tray support modules 122. A fiber can be routed directly to a tray support module 122. Alternatively, a fiber can be re-routed to the other side of the assembly via the two spooling structures 226 of the fiber router and additional fiber retaining fingers 228 of the fiber router. The two spooling structures 226 are positioned above the walls 222 and 224. An example of such a routing path 230 is shown in FIG. 15. The fiber router is unitarily integrated with the piece 162. That is, the walls 222 and 224, the spooling structures 226, and the fiber retaining fingers 228 are all unitarily integrated with the piece 162.

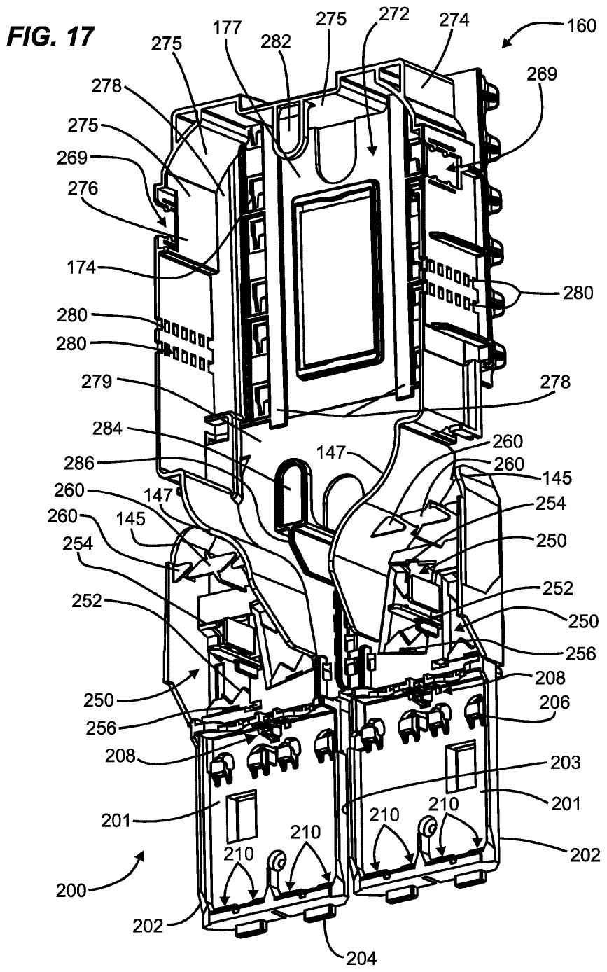

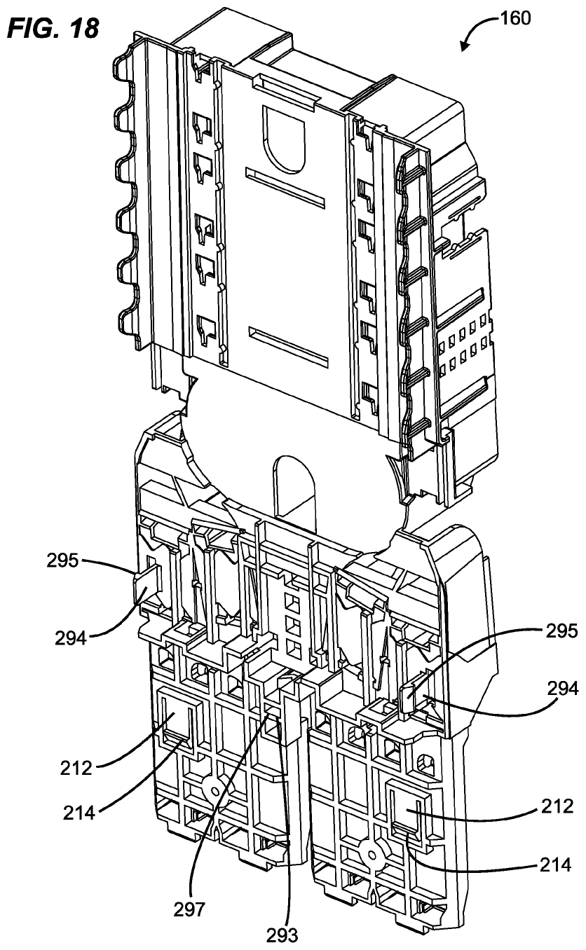

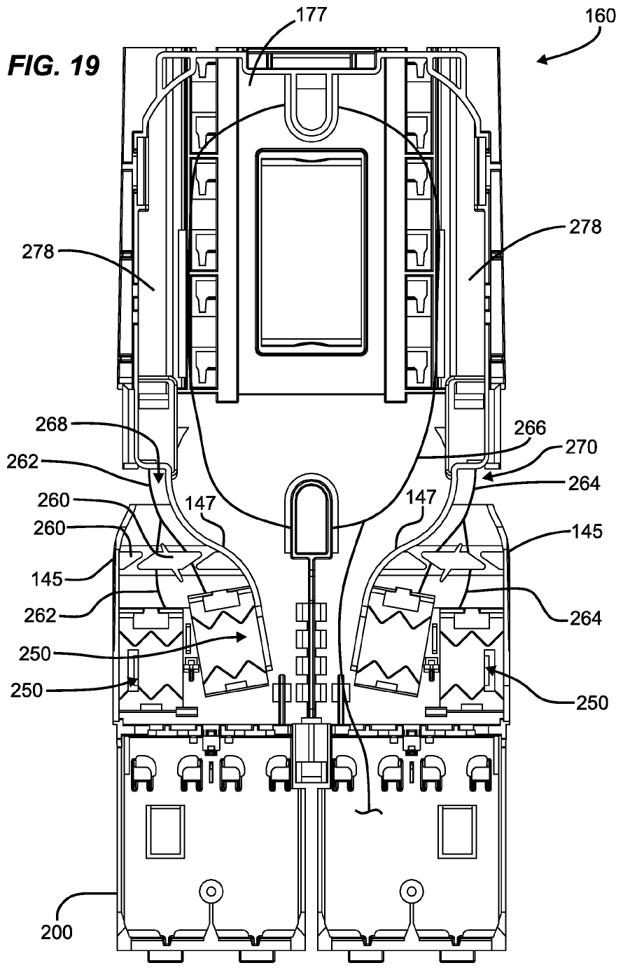

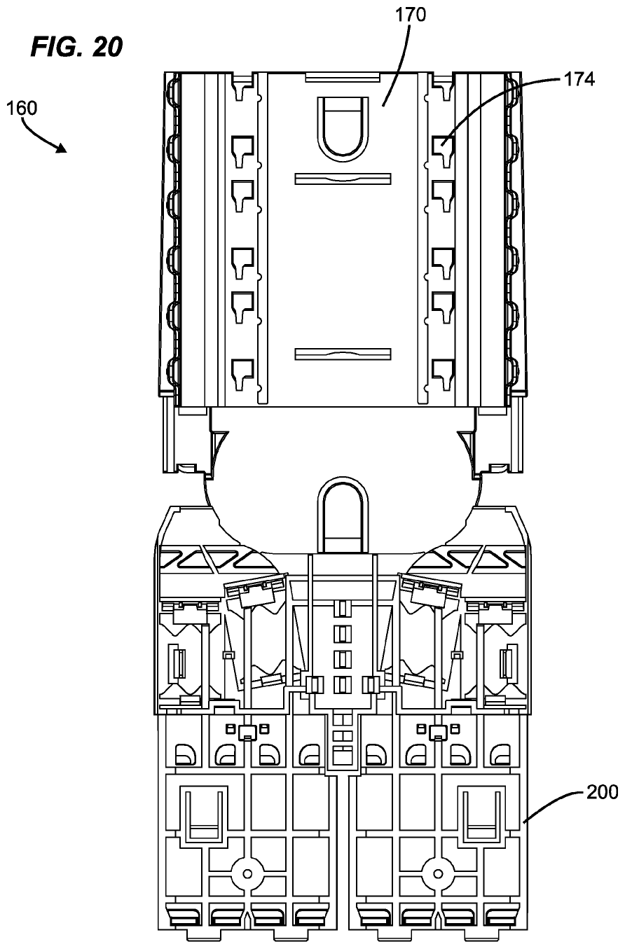

Referring to FIGS. 17-20, the piece 160 is of unitary construction, (e.g., formed in a single molding operation). The piece 160 includes several structures and features unitarily integrated therewith. These structures and features, in turn, provide for multiple cable and fiber management functions of the assembly 100.

The piece 160 includes a baseplate 200. The baseplate 200 can be configured identically to the base plate 200 of the piece 162. Thus, for example, the baseplate 200 of the piece 160 consists of right and left baseplate portions 202. A slot 203 devoid of material separates the right and left baseplate portions 202. The baseplate 200 includes a body having downward projections 204. The downward projections 204 are configured to be received (e.g., by interference fit) in receivers 198 of the piece 164 (FIG. 11) when assembling the pieces 162 and 164 together. In addition, the body of the baseplate 200 includes flexibly resilient tabs 212 having projecting catches 214. The tabs 212 are configured to flex until the catches snap into receivers, or openings 196 of the piece 164 (FIG. 11) to snap-connect the pieces 164 and 160 together. In addition, as mentioned above, the projections 186 are received in complementarily configured openings defined by the piece 160 to further connect the pieces 160 and 164.

The baseplate 200 of the piece 160 includes structures and features for mounting a cable jacket fixation subassembly, which structures and features are unitarily integrated with the piece 160. These structures and features generally project forwards from major forward-facing surfaces 201 of the baseplate 200. These structures and features are identical to those described above with respect to the baseplate 200 of the piece 162, and can be used to mount a subassembly 300 and a retainer 400, as described above.

Above the baseplate 200 the piece 160 defines forwardly recessed pockets 250 having structures 252, 254 and 256. The structures 252 define recesses having shapes that complement projecting shapes of the modules 150. The structures 252 and 254 provide a snap-connection interface for complementarily configured structures of the modules 150. The snap connection securely immobilizes the modules 150 in the recessed pockets 250. The pockets 250 and structures 252, 254, 256 are unitarily integrated with the piece 160. There is a pair of pockets 250 associated with each baseplate portion 202. For each pair of pockets, a longitudinal dimension of one of the pockets is oblique to the longitudinal dimension of the other pocket. In particular, the longitudinal dimension of the pocket of each pair nearer the axis 102 is oblique to a reference line parallel to the axis 102, whereas the longitudinal dimension of the other pocket of each pair is parallel to that reference line. The tilt of the more central of the pockets 250 can help guide fibers gently to the left and right sides of the assembly 100 so that they can enter the fiber management region on the front side of the assembly 100.

Above the pockets 250 and structures 252, 254, 256, the piece 160 includes a fiber router unitarily integrated with the piece 160. The fiber router includes the walls 145 and 147. The walls 145 and 147, together with unitarily integrated fiber retaining fingers 260, define three discrete fiber routing paths.

First fiber routing paths 262 extend from the sheath holder modules at the right side of the piece 160 further to the right side of the assembly 100 and then to the front of the assembly and the fiber router of the piece 162 via a channel 268.

Second fiber routing paths 264 extend from the sheath holder modules at the left side of the piece 160 further to the left side of the assembly 100 and then to the front of the assembly and the fiber router of the piece 162 via a channel 270.

Third fiber routing paths, such as the path 266, extend from the baseplate 200 directly to the storage volume 272 of the basket 274, bypassing the sheath holder modules and the pockets 250 by passing in between them and in between the walls 147. Typically, such fibers will be protected in sheaths and the sheaths stored in loops in the storage volume 272 of the basket 274.

Above the fiber router is the basket 274. The basket 274 includes a loop storage volume 272 defined by an inner surface 275 of an outer perimeter wall 276 and rearward facing surfaces 177, 278 and 279. The wall 276 projects rearwardly from the surfaces 278.

Unitarily integrated with the wall 276 are openings 280. The openings can receive, e.g., a tie wrap or another part to constrain the looped fibers near the wall 276. Also unitarily integrated with the wall 276 are structures 269 that define sockets for mounting additional components to the basket 274, such as fiber loop retainers with adjustable heights.

The raised rib interface 179 is unitarily integrated with the piece 160 and projects rearwardly from the surface 177.

The openings 174 are recessed forwardly relative to the surfaces 278. By recessing the openings 174 in this manner, the T-shaped projections of the tray support modules 122 do not interfere with fiber loops stored in the basket 274.

The basket 274 includes an upper loop retainer 282 and a lower loop retainer 284. Both loop retainers 282 and 284 are unitarily integrated with the piece 160. The loop retainers 282 and 284 are configured to retain the fiber loops between the loop retainers 282 and 284, and the surfaces 177 and 279.

The loop retainer 282 projects downwardly from the wall 276. The loop retainer 284 projects upwardly from a loop retainer support 286. The loop retainer support 286 is unitarily integrated with the piece 160 and projects rearwardly from the surface 279. The loop retainer support 286 can also serve as a path divider for optical fibers extending from the right and left baseplate portions 202.

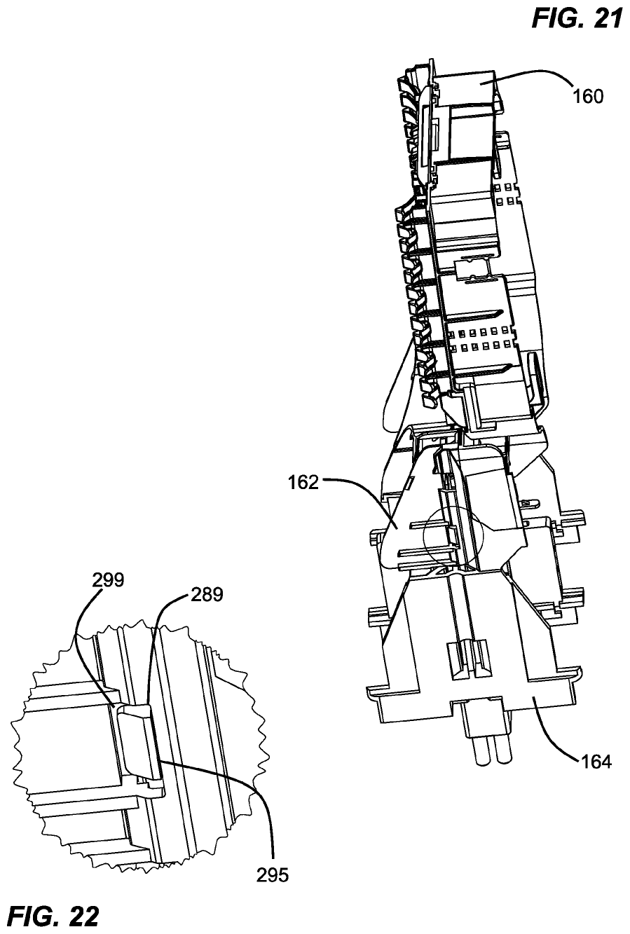

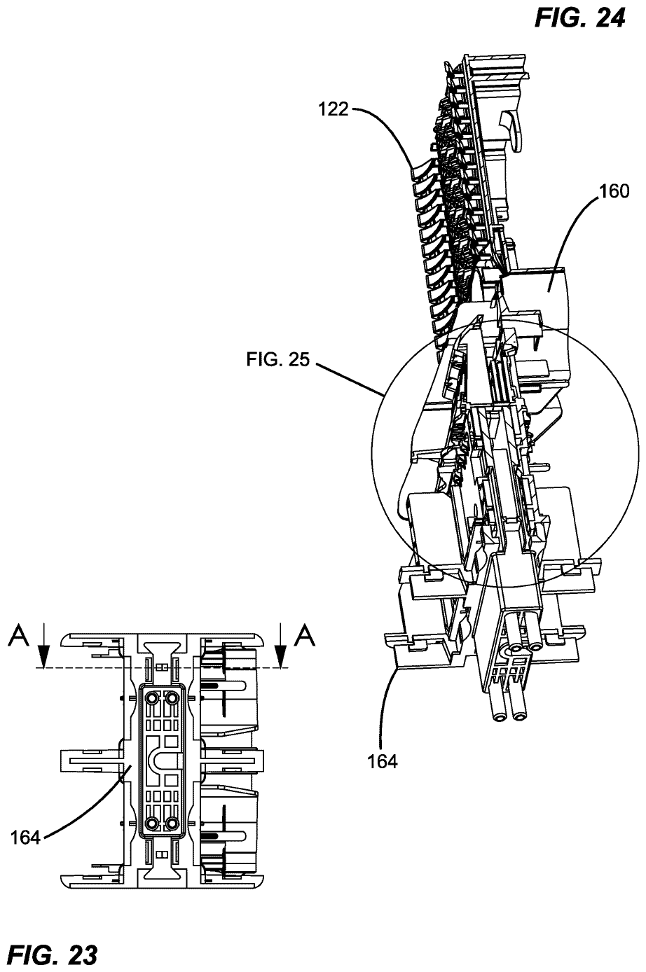

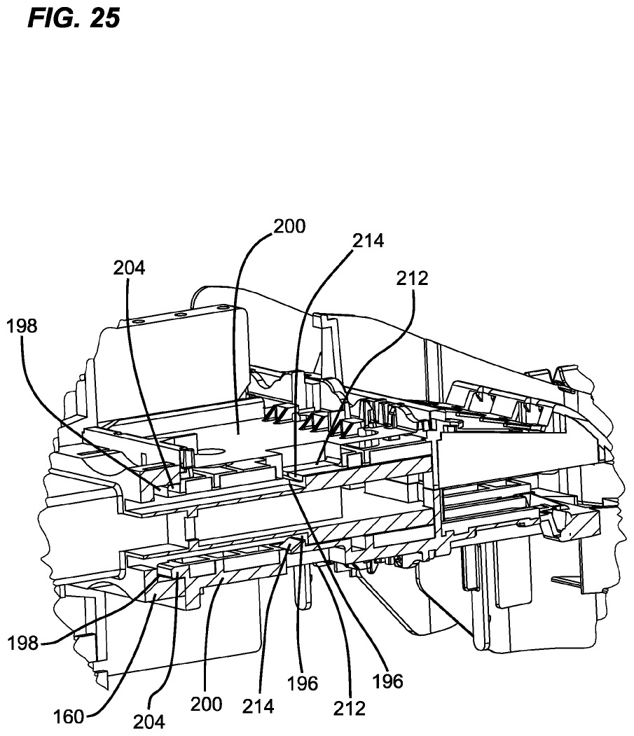

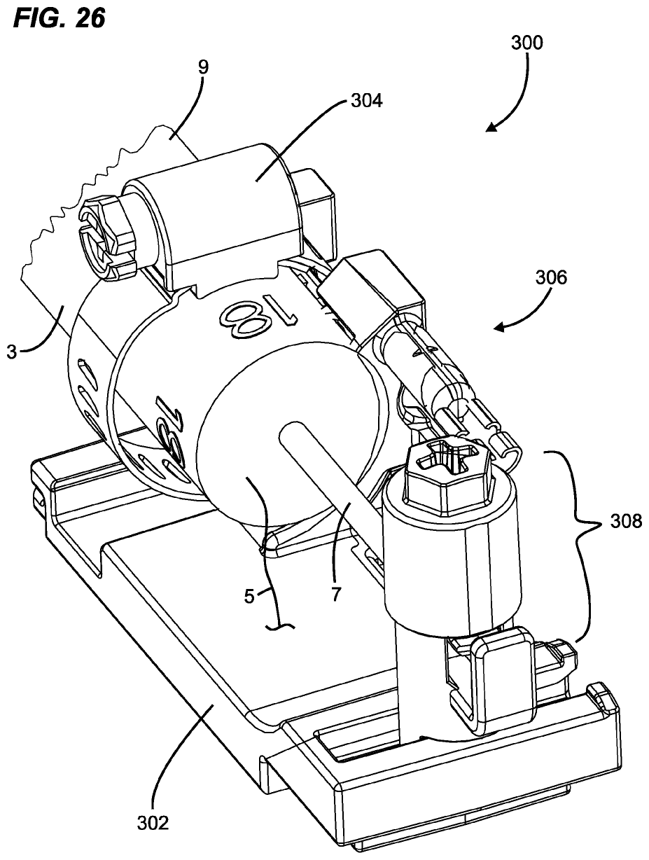

Referring to FIGS. 10-25, each of the pieces 160, 162 and 164 includes unitarily integrated complementary couplers for snap-connecting the pieces 160 and 162 together, and then snap-connecting the subassembly of the pieces 160 and 162 to the piece 164. The piece 162 includes a flexibly resilient tab 290 projecting rearwardly and having a catch 291 configured to snappingly engage a shoulder 297 of the piece 160. The tab 290 is received in an opening 293 defined by the shoulder 297 until the catch 291 snappingly engages the shoulder 297. In addition, the piece 160 includes flexibly resilient tabs 294 having projecting catches 295. The tabs 294 enter openings 299 defined by the piece 162 and snappingly engage shoulders 289 defined by the openings 299. In this manner, the pieces 160 and 162 can be snap-connected together at multiple connection points by engaging each other horizontally and back-to-back. When snap-connected together, the baseplates 200 of the pieces 160 and 162 are horizontally aligned and back-to-back.

The subassembly of snap-connected pieces 160 and 162 can then be slid downward into snap-connection with the piece 164. The snap-connection interface between the piece 164 and the subassembly of pieces 160 and 162 includes the snap-engagement of the catches 214 in the openings or recesses 196 and the downward insertion of the projections 204 into the receivers 198. In addition, as the subassembly moves downward relative to the piece 164 (and/or the piece 164 moves upward relative to the subassembly) the dividers 188 and 190 are received in the slots 203 of the baseplates 200.

In this manner, an assembly having all of the features and functions unitarily integrated into pieces 160, 162 and 164 can be assembled, advantageously, in two snap-connect operations that are perpendicular to each other.

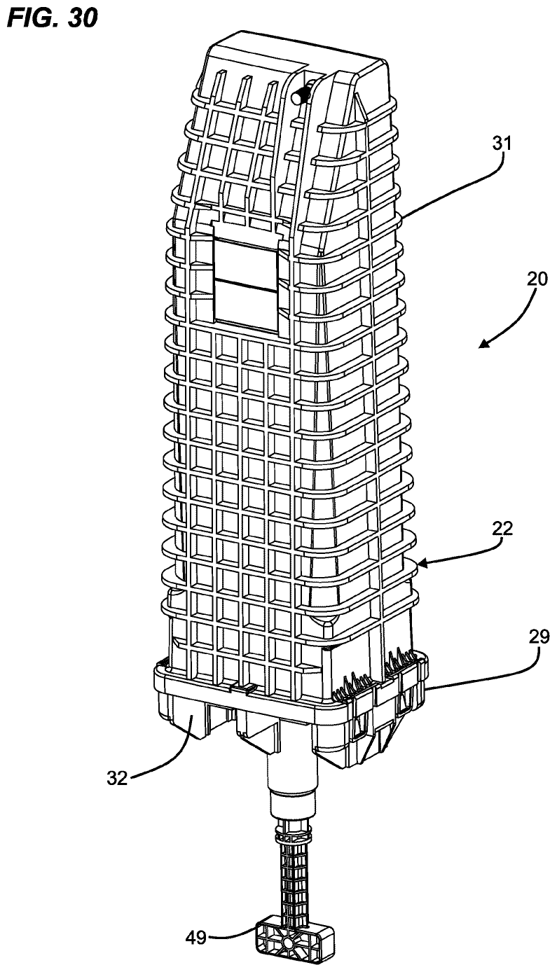

FIG. 30 shows other example telecommunications equipment, e.g., another example enclosure (or closure) 20 in accordance with the principles of the present disclosure. The enclosure 20 includes a housing 22 defining an interior volume having an opening. The enclosure includes a cable sealing unit that mounts within the opening of the housing 22 for sealing about one or more cables desired to be routed into the interior volume of the housing 22 through the opening. For example, the sealing unit can include the seal blocks 131 (FIG. 3). In the example shown, the housing 22 includes a cover 31 (e.g., a dome style cover) defining the opening at one end 29, and a base 32 that mounts to the end 29 of the cover 31. In certain examples, the base 32 can be detachably secured to the cover 31 by a mechanical fastening arrangement that can include latches, clamps, fasteners, or the like. The cable sealing unit can be retained in the opening 26 by the base 32. An optical fiber management assembly (such as the assembly 100 described above or the assembly 500 described below), which support fiber optic components (e.g., optical fiber splice trays, optical fiber splitter trays, etc.) can be carried with the sealing unit. In one example, the cable sealing unit includes sealant (e.g., a sealant arrangement such as the seal blocks 131, a volume of sealant that may be formed by one or more sections or blocks of sealant, etc.) defining a plurality of cable pass-through locations (e.g., ports, interfaces between adjacent sections of sealant, etc.). When pressurized, the sealant is configured for providing seals about structures (e.g., cables, plugs, etc.) routed though the pass-through locations of the sealant and is also configured for providing a peripheral seal between the housing 22 and the cable sealing unit about the boundary (e.g., perimeter, profile, etc.) of the opening.

The cable sealing unit includes an actuator arrangement 49 for pressurizing the sealant within the opening once cables have been routed through the sealant during installation of the enclosure 20 in the field.

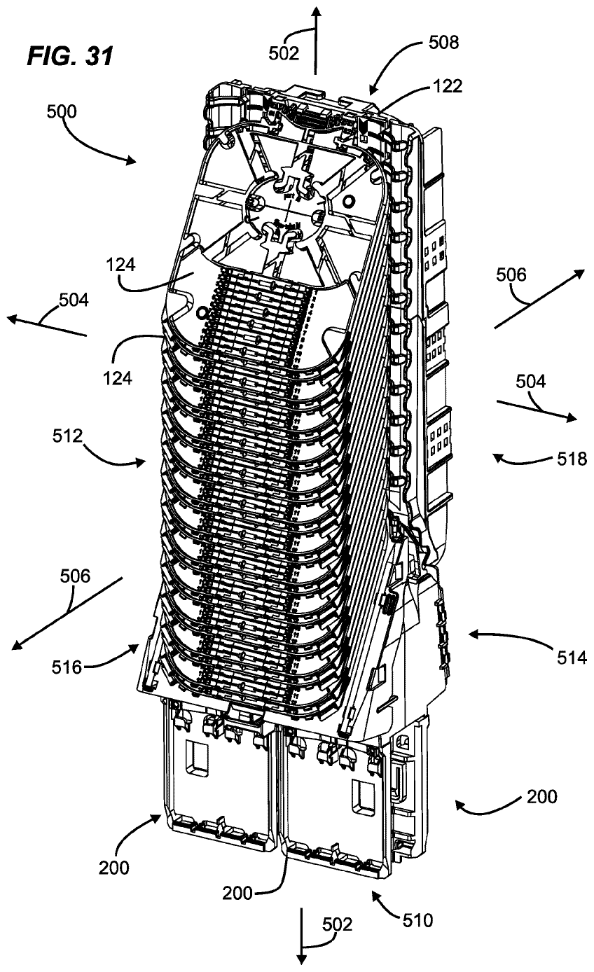

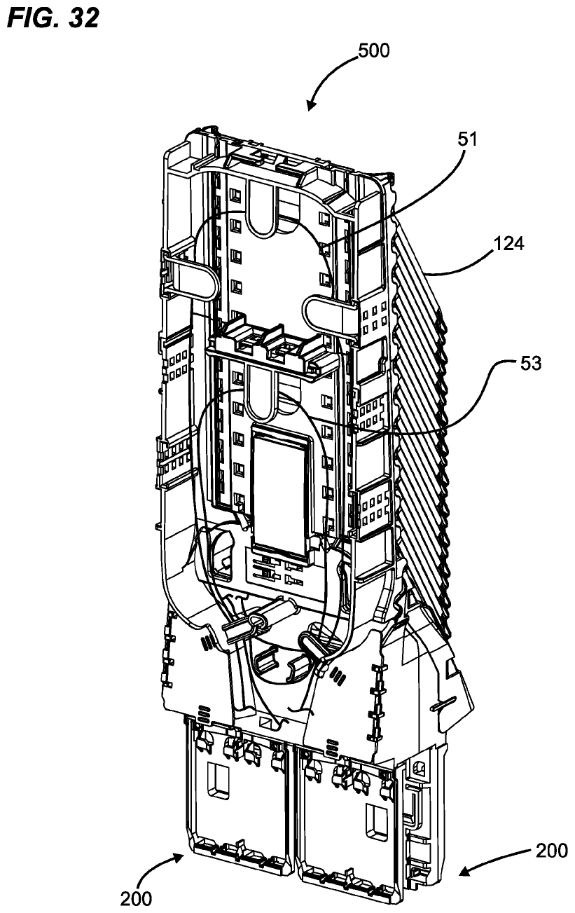

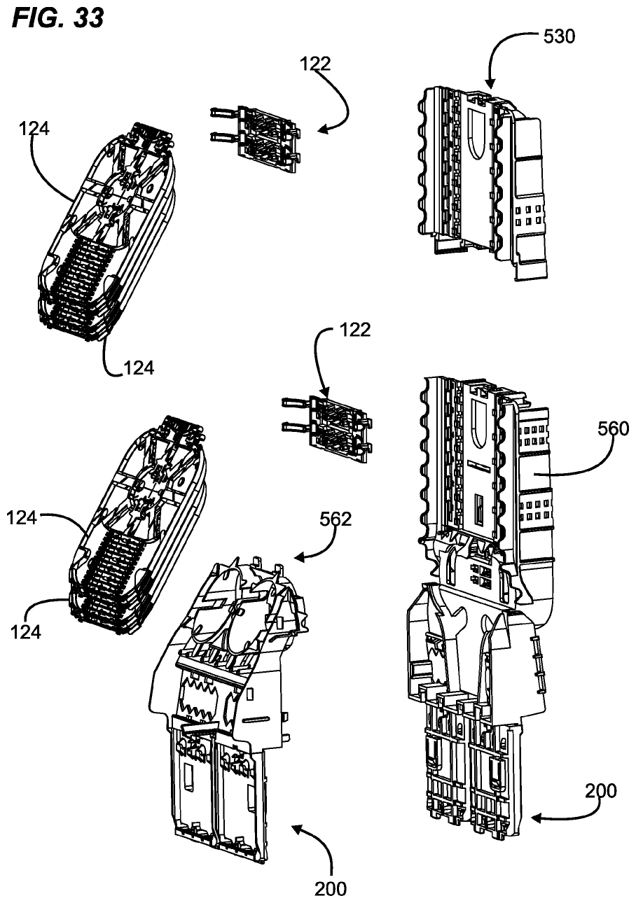

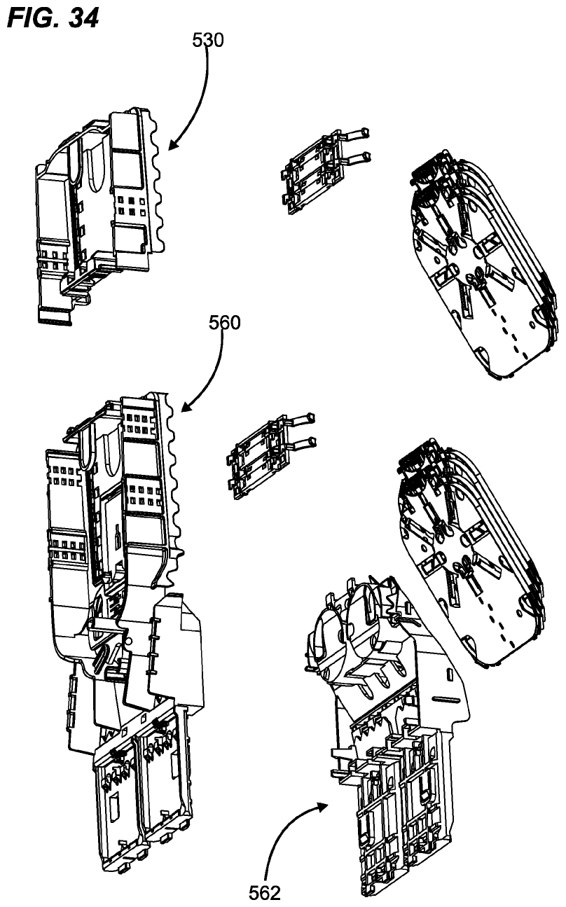

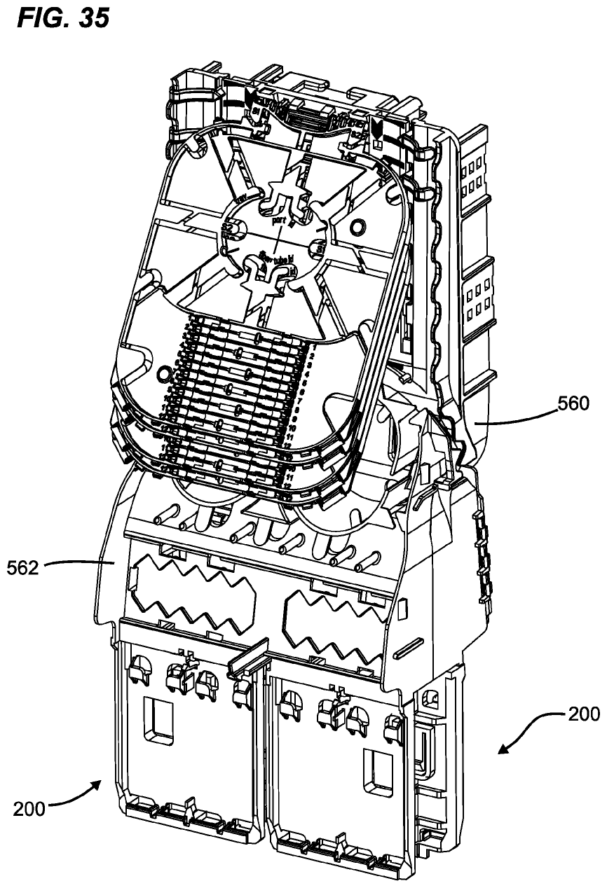

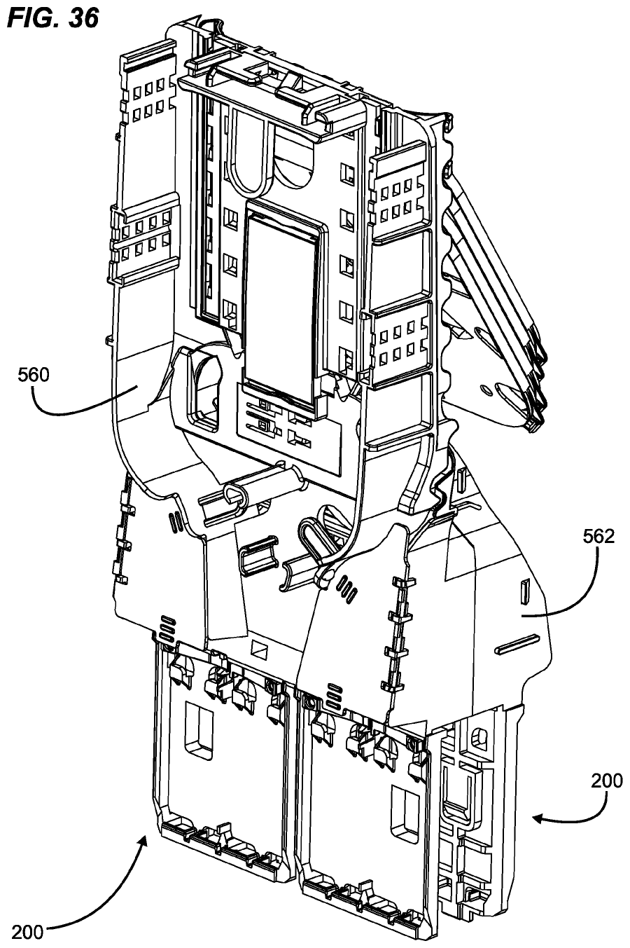

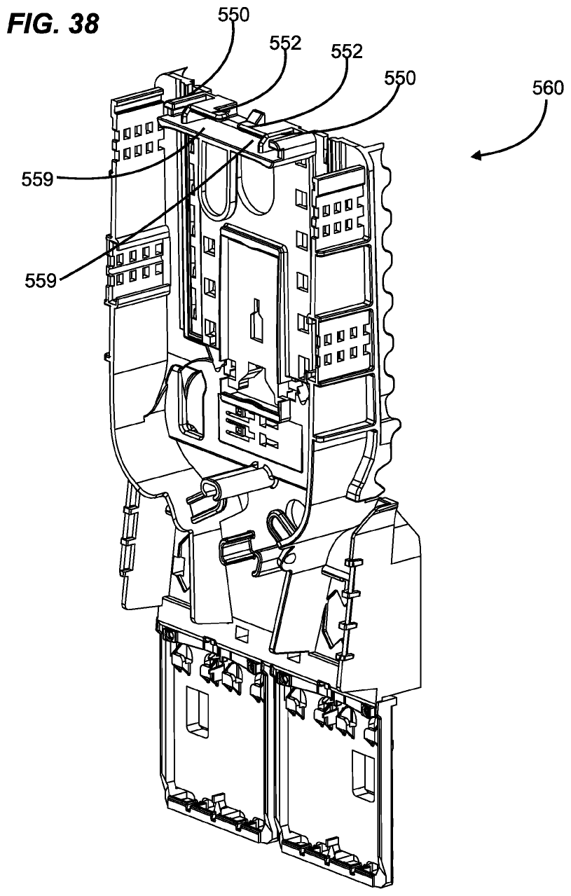

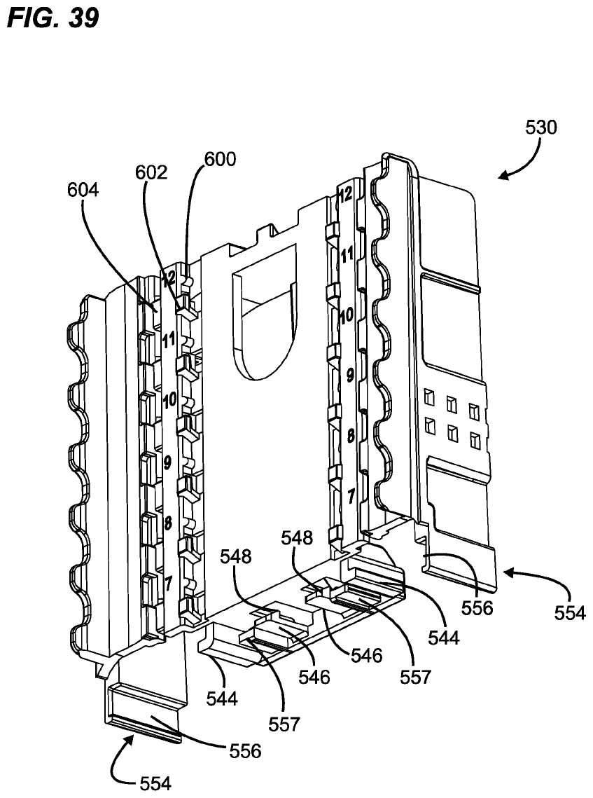

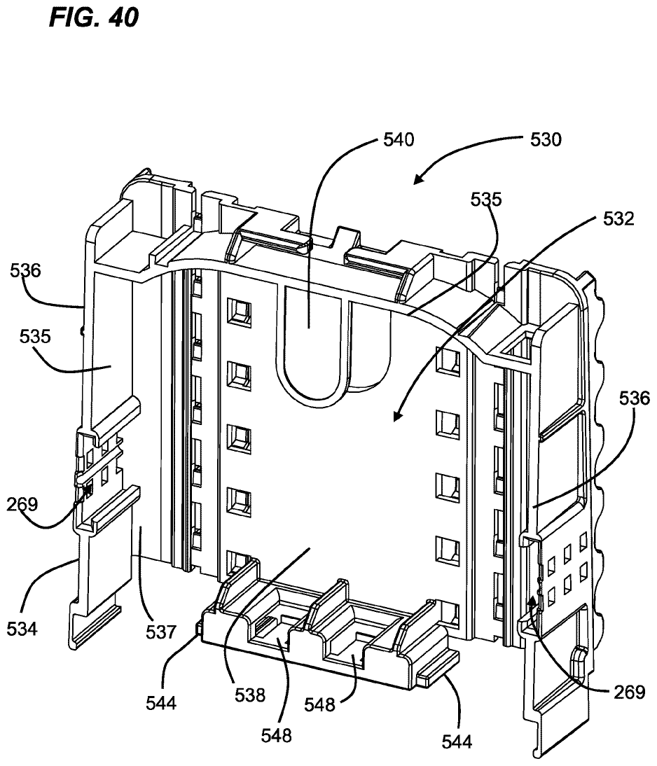

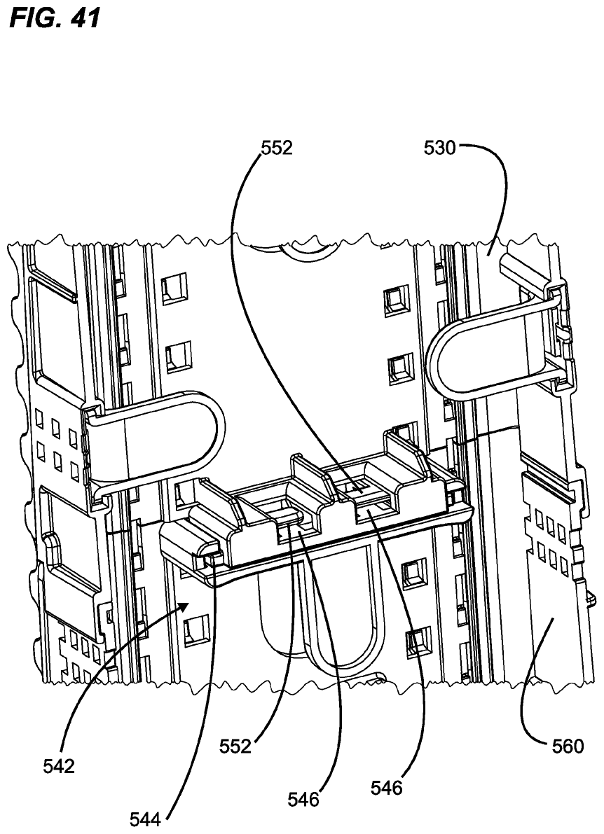

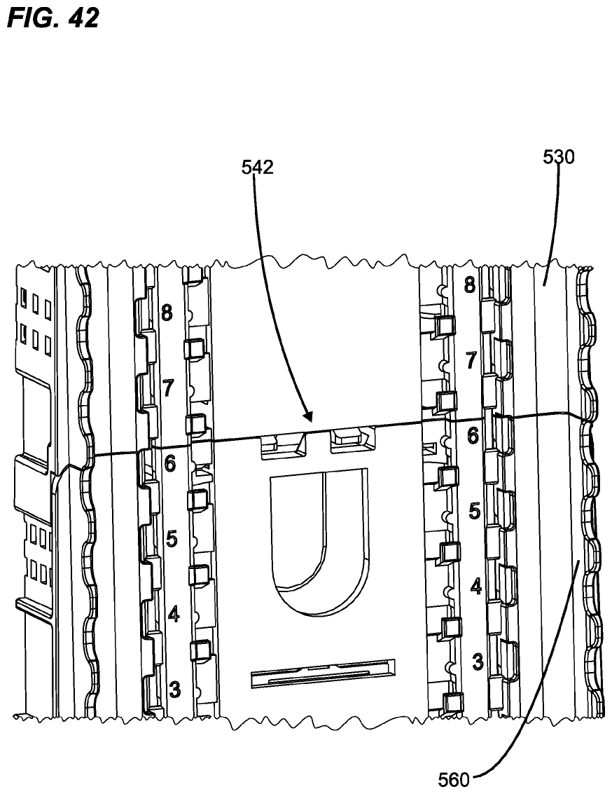

Referring to FIGS. 31-42, components of a further example fiber management assembly 500 in accordance with the disclosure will be described. The assembly 500 has a first configuration (FIGS. 31 and 32) and a second configuration (FIGS. 35 and 36). The assembly is configured to be easily expanded from the second configuration to the first configuration, and to be contracted from the first configuration to the second configuration. For example, depending on specific fiber management needs at a given closure, as well as the size of the closure (e.g., the size of the dome cover), more fiber management or less fiber management may be needed.

For example, for a given network location (e.g., a telephone pole or handhole) a given assembly of a given closure may need to handle more optical fiber splices and optical fiber connections than it did previously, warranting expansion of the fiber management assembly to an expanded configuration from the second configuration to the first configuration. In another example, it may be feasible, at a given network distribution location, to downsize the size of the closure (which can, e.g., reduce cost and weight of the closure), warranting contraction of the fiber management assembly, from the first configuration to the second configuration.

The assembly 500 is configured to enable quick and simple conversion between the first and second configurations.

Many of the features of the assembly 500, as shown in the drawings, are identical to those described above with respect to the assembly 100. In the interest of brevity, the following discussion with therefore largely focus on differences between the assembly 500 and the assembly 100.

The assembly 500 defines a first axis, or vertical axis 502, a second axis 504, and a third axis 506. The first axis 502, the second axis 504, and the third axis 506 are mutually perpendicular. The second axis 504 and the third axis 506 define a horizontal plane. The assembly 500 extends from a top 508 to a bottom 510 along the first axis 502. The assembly 500 extends from a first side 512 to a second side 514 along the second axis 504. The assembly 500 extends from a front 516 to a back 518 along the third axis 506.

The assembly 500 includes a vertical stack of the fiber management tray support modules 122. The stack 123 is mounted at a front of the assembly 500. The stack 123 includes a selectable number of modules 122 stacked along a stacking axis, which is parallel to the axis 102 and can be increased by introducing the piece 530 to the assembly.

Each module 122 pivotally supports a plurality of optical fiber management trays 124, as described with respect to the assembly 100.

The assembly 500 includes each of the following pieces of unitary construction: a piece 560, a basket expansion piece 530, and a piece 562. Optionally the assembly 500 can include one or more modules 122 and/or one or more trays 124.

The piece 562 functions in the same manner and serves the same purpose as the piece 162 described above.

The piece 560 functions in the same manner and serves the same purpose as the piece 160 described above.

The pieces 560, 530 and 562 are configured to snap connect to one another. In particular, the pieces 560 and 562 snap-connect to each other in the same or similar manner as described with respect to the pieces 160 and 162. To create the larger configuration of FIGS. 31-32 (e.g., to convert the assembly of FIGS. 35-46 to that of FIGS. 31-32), the pieces 530 and 560 snap-connect to each other as will be described in greater detail below.

Each of the pieces 560 and 562 includes a baseplate 200 for mounting one or more cable fixation subassemblies, such as the subassembly 300 described above. In addition, the baseplates 200 are configured to snap connect to the third piece 164, as described above (FIG. 10).

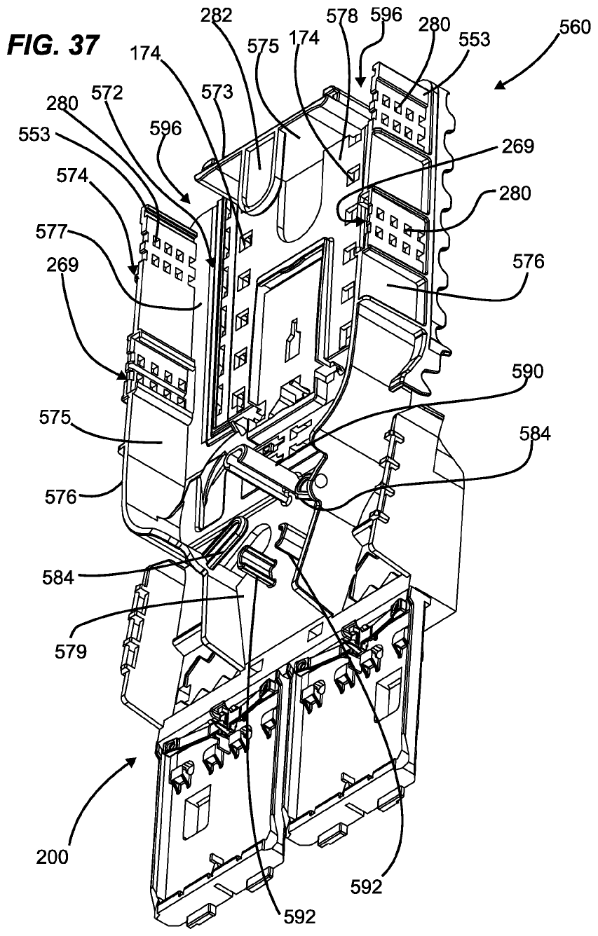

Referring to FIGS. 37-42, the pieces 560 and 530 will be described.

Fiber routing paths, extend from the baseplate 200 of the piece 560 to the storage volume 572 of the basket 574 of the piece 560, Typically, such fibers will be protected in sheaths and the sheaths stored in loops in the storage volume 572 of the basket 574.

The basket 574 includes the loop storage volume 572 defined by inner surfaces 575 of outer perimeter walls 576, 573 and rearward facing surfaces 577, 578 and 579. The walls 576, 573 project rearwardly from the surfaces 577, 578.

Unitarily integrated with two of the walls 576, 573 are openings 280. The openings 280 can receive, e.g., a tie wrap or another part to constrain the looped fibers near the walls 576, 573. Also unitarily integrated with two of the walls 576, 573 are structures 269 that define sockets for mounting additional components to the basket 574, such as adjustable fiber loop retainers.

The basket 574 includes an upper loop retainer 282 and lower loop retainers 584. The loop retainers 282 and 584 can be unitarily integrated with the piece 560. The loop retainers 282 and 584 are configured to retain the fiber loops between the loop retainers 282 and 584, and the surfaces 577, 578, 579.

The loop retainer 282 projects downwardly from the topmost of the walls 573. The loop retainers 584 project obliquely to the axes 502 and 504 from the side walls 576. Curved projections 590 and 592 projecting rearwardly from the surface 579 can serve as path dividers for optical fibers extending from the right and left portions of the base plate 200. For example, a sheath of fibers can be routed from the right base plate portion about the outside of the left projection 592 to form a clockwise loop (when observed from the back of the assembly), while another sheath of fibers can be routed from the left base plate portion about the outside of the right projection 592 to form a counterclockwise loop (when observed from the back of the assembly). The projection 590 can serve as a guide post for routing of portions of fiber loops, and/or as a loop retaining point at the bottom of loops.

Between the side walls 576 and the top wall 573 are gaps (e.g., material voids) 596. The gaps 596 between the basket walls of the piece 560 permit optical fibers to continue into the expansion piece 530 for larger storage loops and/or additional loops of fiber when the assembly 500 is configured as in FIG. 31. The gaps 596 can be positioned on either side or, alternatively, on both sides (as shown) of the top wall 573.

The piece 530 defines an extension basket portion 534. The extension basket portion 534 includes a loop storage volume 532 defined by inner surfaces 535 of one or more outer perimeter walls 536 and rearward facing surfaces 537, 538 and 539. The wall(s) 536 project rearwardly from the surfaces 537.

Unitarily integrated with one or more portions of the wall(s) 536 are openings 280. The openings 280 can receive, e.g., a tie wrap or another part to constrain the looped fibers near the wall(s). Also unitarily integrated with two of the wall(s) 536 are structures 269 that define sockets for mounting additional components to the extension basket portion 534, such as adjustable fiber loop retainers.

The extension basket portion 534 includes an upper loop retainer 540 unitarily integrated with the piece 530. The loop retainer 540 is configured to cooperate with loop retainers mounted to the structures 269 and the loop retainers 584 of the piece 560 to retain the fiber loops between the loop retainers 540,584, and the surfaces 577, 578, 579, 537, 538.

The pieces 530 and 560 are configured to snap-connect together at an interface 542 in order to form the expanded basket that combines the baskets of the pieces 530 and 560 into a single basket for larger fiber loops and/or storage of more fiber length (e.g., to increase the fiber management capacity of the piece 560 overall, as well as that of the basket of the piece 560). With the pieces 530 and 560 connected together, portions of the outer perimeter wall(s) 536 of the piece 530 become continuous with side walls 576 of the piece 560 at the interface of the two pieces 530 and 560, with rearward facing surfaces of the basket portions of the two pieces 530 and 560 likewise being continuous at the interface between the pieces 530, 560.

The interface 542 between the pieces 530 and 560 is formed at the bottom of the piece 530 and the top of the piece 560. The interface 542 is formed by complementary unitarily integrated coupling features of the pieces 530 and 560. The piece 530 can be slid forward (e.g., parallel to the axis 506 and perpendicular to the axis 502) into snap connection engagement with the piece 560 (or the piece 560 can be slid rearwardly into snap connection engagement with the piece 530).

In particular, the piece 530 includes L-shaped guide tabs 544 and flexibly resilient latch arms 546 having catches 548. The piece 560 includes L-shaped guide slots 550 and shoulders 552. To snap lock together the pieces 530 and 560 the tabs 544 are slid into the slots 550 until the catches 548 snappingly engage the shoulders 552. The slots 550 are blind, acting as a forward slide stop for the shoulders 552. In addition, for further stability of the interface 542, stabilizer projections 557 of the piece 530 are slidingly received in receivers 559 of the piece 560 and recesses 556 of wall formations 554 of the wall(s) 536 slidingly receive complementarily configured structures 553 of the walls 576 of the piece 560.

Referring to FIG. 32, example fiber loop routing paths 51 and 53 are illustrated for the expanded and contracted configurations of the assembly 500. The path 53 can be appropriate regardless of the configuration of the assembly 500. The path 51 can be appropriate for larger loop storage and/or for storage of additional loops fibers when the assembly 500 is in an expanded stated for management of additional optical fibers.

The piece 530 at its front includes structures 600, 602, 604 for mounting by snap-connection one or more additional module(s) 122 which, in turn, can pivotally support additional fiber management trays 124. Thus, in the expanded state of the assembly 500, fiber management capacity is increased both at the front of the piece 530 with the possibility of adding additional fiber management components (such as splice trays) to the assembly, and with the possibility of adding additional fiber loop storage capacity at the back of the piece 130.

To complement and be accommodated by dome covers of closures that are tapered as they extend away from the closure base along the axis 502, both the piece 560 and the piece 530 can taper as they extend away from the baseplate 200, with the tapered side-to-side dimension and/or front-to-back dimension of the piece 530 matching the corresponding tapered width(s) of the piece 560 at the interface 542. That is, in some examples, when the pieces 530 and 560 are connected to each other, the taper of the overall assembly 500 is continuous and uninterrupted.

Various modifications and alterations of this disclosure will become apparent to those skilled in the art without departing from the scope and spirit of this disclosure, and it should be understood that the scope of this disclosure is not to be unduly limited to the illustrative examples set forth herein.

What is claimed is:

1. An optical fiber management assembly, comprising:
a piece including, unitarily integrated therewith, at least two of:
(i) a baseplate for mounting a portion of a cable jacket fixation subassembly to the baseplate;
(ii) a basket for storing loops of optical fibers; and
(iii) a fiber router including a structure for mounting a fiber sheath holder module to the fiber router.

2. An optical fiber management assembly, comprising:
a piece including, unitarily integrated therewith:
(i) a baseplate for mounting a portion of a cable jacket fixation subassembly to the baseplate;
(ii) a basket for storing loops of optical fibers; and
(iii) a fiber router including a structure for mounting a fiber sheath holder module to the fiber router, the fiber router being positioned between the baseplate and the basket.

3. The assembly of any of claims 1-2,
wherein the piece includes walls that define a fiber pathway from the baseplate to the basket that bypasses the fiber router.

4. The assembly of any of claims 1-3, wherein the basket defines structures for mounting tray support modules configured to pivotally support fiber management trays arranged in a stack.

5. The assembly of any of claims 1-4,
wherein the piece is a first piece;
wherein the fiber router is a first fiber router;
wherein the baseplate is a first baseplate, the assembly further comprising a second piece configured to snappingly connect to the first piece, the second piece including a second baseplate for mounting a portion of a cable jacket fixation subassembly to the second baseplate and a second fiber router, the second fiber router including two spool structures.

6. The assembly of claim 5, wherein the second piece includes a structure for mounting a fiber sheath holding module.

7. The assembly of any of claims 5-6, wherein the first piece and the second piece are configured to be snappingly connected to each other such that the first baseplate is back-to-back with the second baseplate.

8. The assembly of any of claims 5-7, further comprising a third piece, the third piece including first pockets configured to receive seal blocks for sealing around fiber optic cables and second pockets configured differently from the first pockets, the second pockets being configured to snappingly connect with the first piece and the second piece.

9. The assembly of any of claims 5-8,
wherein the first piece includes first fiber guide walls that define:
a first fiber routing path from the first baseplate to the storage volume of the basket; and
second fiber routing paths discrete from the first fiber routing path, the second fiber routing paths being from the first fiber router to the spool structures; and
wherein the second piece includes fiber guide walls that define a third fiber routing path discrete from the first fiber routing path and discrete from the second fiber routing path, the third fiber routing path being from the second baseplate to the spool structures.

10. The assembly of any of claims 1-4,
wherein the piece is a first piece, the assembly further comprising:
a second piece, the second piece including first pockets configured to receive seal blocks for sealing around fiber optic cables and a second pocket configured differently from the first pockets, the second pocket being configured to snappingly connect with the first piece.

11. The assembly of any of claims 1-10, wherein the basket includes, unitarily integrated with the piece or the first piece, a fiber loop retainer.

12. The assembly of any of claims 1-11, further comprising any one of, or any two of, or all three of:
a fiber sheath holder module;
a tray support module configured to pivotally support fiber management trays arranged in a stack; and
a fiber management tray.

13. The assembly of any of claims 1-11, further comprising a tray support module mounted at a surface of the piece or the first piece that faces away from a storage volume of the basket, the tray support module being configured to pivotally support fiber management trays arranged in a stack.

14. The assembly of claim 13,
wherein the piece or the first piece includes fiber guide walls that define:
a first fiber routing path from the baseplate or the first baseplate to the storage volume of the basket; and
a second fiber routing path discrete from the first fiber routing path, the second fiber routing path being from the baseplate or the first baseplate to the tray support module.

15. The assembly of any of claims 1-2, wherein the piece comprises a molded polymeric material.

16. The assembly of any of claims 5-10, wherein the pieces snap-connect together with flexibly resilient tabs having catches that snap into openings defining shoulders.

17. The assembly of any of claims 1-2, wherein the baseplate includes a first region for mounting a portion of a cable jacket fixation subassembly and a second region for mounting a cable jacket termination unit, the first region and the second region being separated from each other by a slot defined by the baseplate.

18. The assembly of claim 17,
wherein the piece is a first piece, the assembly further comprising:
a second piece, the second piece including first pockets configured to receive seal blocks for sealing around fiber optic cables and second pockets configured differently from the first pockets, the second pockets being configured to snappingly connect with the first piece such that the slot receives a wall of the second piece that separates the second pockets.

19. A telecommunications closure, comprising
one or more housing pieces configured to cooperate to define a sealed and re-enterable closure volume; and
the assembly of any of claims 1-18 positioned within the closure volume.

20. The closure of claim 19, further comprising fiber optic cables entering the closure volume through cable ports defined by the closure.

21. An optical fiber management assembly, comprising:
a basket for storing loops of optical fibers; and
a basket expansion piece configured to snap connect to the basket to expand the size of the basket and increase optical fiber loop storage capacity of the basket.

22. The optical fiber management assembly of claim 21, wherein the basket and the basket expansion piece include structures for mounting modules configured to pivotally support optical fiber management trays, such as splice trays.

23. The optical fiber management assembly of any of claims 21-22, wherein the basket and the basket expansion piece define a continuous, uninterrupted taper of the assembly when the basket and the basket expansion piece are snap-connected together.

24. The optical fiber management assembly of any of claims 21-23, wherein outer perimeter walls of the basket define gaps therethrough through which optical fibers can extend from an interior basket volume of the basket to an interior basket volume of the basket expansion piece when the basket and the basket expansion piece are snap-connected together.

25. The optical fiber management assembly of any of claims 21-24, wherein the basket and the basket expansion piece are configured to snap connect to each other by sliding one of the basket and the basket expansion piece with respect to the other of the basket and the basket expansion piece in a direction perpendicular to a dimension by which the basket expansion piece increases a dimension of the basket.

26. The optical fiber management assembly of any of claims 21-25, wherein the basket is a portion of a piece of unitary construction that includes a fiber router and a baseplate configured to mount a cable fixation subassembly.

27. A telecommunications closure, comprising
one or more housing pieces configured to cooperate to define a sealed and re-enterable closure volume; and
the assembly of any of claims 21-26 positioned within the closure volume.

28. The closure of claim 27, further comprising fiber optic cables entering the closure volume through cable ports defined by the closure.

29. The assembly of any of claims 1-18, further comprising a basket expansion piece configured to snap connect to the basket to expand the size of the basket and increase optical fiber loop storage capacity of the basket.
